(19) United States
(12) Patent Application Publication
(10) Pub. No.: US 2024/0378803 A1
(43) Pub. Date: Nov. 14, 2024

(54) METHOD AND SYSTEM FOR HARMONIZING PERCEPTUAL QUALITY OF MULTIPLE APPLICATIONS IN EXTENDED REALITY (XR) ENVIRONMENT

(71) Applicant: Samsung Electronics Co., Ltd., Suwon-si (KR)

(72) Inventors: Ravi SURANA, Bangalore (IN); Prasenjit CHAKRABORTY, Bangalore (IN); Erik GUTTMAN, Bangalore (IN); Hyunkoo YANG, Suwon- si (KR); Naveen KOLATI, Bangalore (IN); Siva Prasad GUNDUR, Bangalore (IN); Abhishek SONI, Bangalore (IN); Aranya SAMAIYAR, Bangalore (IN)

(21) Appl. No.: 18/638,057

(22) Filed: Apr. 17, 2024

Related U.S. Application Data
(63) Continuation of application No. PCT/KR2024/004751, filed on Apr. 9, 2024.

(30) Foreign Application Priority Data
May 12, 2023 (IN) 202341033717
Oct. 19, 2023 (IN) 2023 41033717

(51) Int. Cl. G06T 17/00; G06T 7/70

(52) U.S. Cl. CPC G06T 17/00; G06T 7/70; G06T 2207/30168

(57) ABSTRACT

A method and system for harmonizing perceptual, quality of multiple applications in extended reality (XR) environment are provided. The method includes receiving, by an XR device, at least one media stream received from each application of plurality of applications in the XR device, determining a perceptual quality score for at least one media stream received from each application of the plurality of applications, determining at least one candidate application with different media quality from plurality of applications based on determined perceptual quality score for at least one media stream received from each application of the plurality of applications, determining a target perceptual quality score for at least one media stream for at least one candidate application based on the perceptual quality score and network parameters, and harmonizing, at least one media parameter of the at least one media stream received from candidate applications based on the target perceptual quality score.

### CROSS-REFERENCE TO RELATED APPLICATION(S)

This application is a continuation application, claiming priority under § 365(c), of an International application No. PCT/KR2024/004751, filed on Apr. 9, 2024, which is based on and claim the benefit of an Indian provisional patent application number 202341033717, filed on May 12, 2023, in the Indian Intellectual Property Office, and of an Indian Non-Provisional patent application number 202341033717, filed on Oct. 19, 2023, in the Indian Intellectual Property Office, the disclosure of each of which is incorporated by reference herein in its entirety.

### FIELD OF INVENTION

The disclosure relates to extended reality (XR) technology. More particularly, the disclosure relates to harmonizing perceptual quality of multiple applications in an XR environment.

### BACKGROUND

In general, extended reality (XR) is a combination of human and computer-generated graphics interaction. The XR creates a state of immersive digital experience in which physical and digital objects coexist in real time. Further, the XR includes augmented reality (AR), virtual reality (VR) and mixed reality (MR). The augmented reality (AR) is an integration of digital information with user's environment in real time. Some of the real time applications of AR used in mobile devices includes but not limited to e-commerce applications (e.g., Amikasa, three-dimensional (3D) floor planner, or the like), gaming applications (e.g., Pokemon Go), and travel and tourism applications (google translate app). The virtual reality (VR) is a complete computer-generated environment with scenes and objects which appears to be real, and making the user feel immersed in the virtual environment. The VR is used in one or more applications, such as gaming, healthcare, education and the like. In addition, the mixed reality is combination of augmented reality and virtual reality in which the physical reality and digital contents are combined such that it enables the interaction between real-world and virtual objects. The one or more application of AR, VR and MR can be used in mobile devices and VR devices respectively. The VR device is a head-mounted device that provides virtual reality for the wearer. In existing systems, the XR devices is capable of running multiple applications simultaneously. Further, the multiple applications can be viewed simultaneously and the user can interact concurrently with multiple applications running on the XR device. Further, each of the multiple applications can be streamed with different qualities. However, using multiple applications in the XR device with different qualities leads to poor user experience and reduced immersiveness by the user using the XR device. Thus, there is a need for an improved method and system to achieve similar quality of streams for multiple applications running on the XR device and hence improve the user experience Hence, it is desired to address the above-mentioned disadvantages or other shortcomings or at least provide a useful alternative.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of harmonizing perceptual quality of multiple applications in an extended reality (XR) environment.

Another aspect of the disclosure is to determine and compare the perceptual quality scores to perform parameter renegotiation for harmonizing the quality of streams of multiple applications running on XR device.

Another aspect of the disclosure is to determine and compare the perceptual quality scores to post data processing for harmonizing the quality of streams of multiple applications running on XR device.

Another aspect of the disclosure is to achieve similar quality scores for multiple streams of multiple applications to provide an even and smooth user observation while using XR devices.

Another aspect of the disclosure is to enhance the user immersiveness while using multiple applications in the XR device.

Another aspect of the disclosure is to display the multiple streams simultaneously for which the quality of streams is even for multiple steams associated with multiple application.

Additional aspects will be set forth in part in the description which follows and, in part, will be apparent from the description, or may be learned by practice of the presented embodiments.

In accordance with an aspect of the disclosure, a method of harmonizing perceptual quality of multiple applications in an extended reality (XR) environment is provided. The method includes receiving, by an XR device, at least one media stream from each application among plurality of applications available in the XR device, determining a perceptual quality score for media stream received from each application of the plurality of applications, determining at least one candidate application with different media quality from plurality of applications based on perceptual score of at least one media stream received from each application, determining, a target perceptual quality score for the at least one media stream of the at least one candidate application based on the perceptual quality score of media stream received from each of the application of the plurality of applications and plurality of network parameters, and harmonizing at least one media parameter of the at least one media stream received from at least one candidate application based on the target perceptual quality score.

In an embodiment of the disclosure, the at least one media parameter includes a bit-rate, a codec, a resolution, a brightness, a frame-complexity, a sample rate, a channel count, a pitch, and a frame-rate.

In an embodiment of the disclosure, the determining of the target perceptual quality score for the at least one media stream of the at least one candidate application based on the perceptual quality score for the at least one media stream received from each application of the plurality of applications and the plurality of network parameters includes determining, a bandwidth ratio based on the plurality of network parameters. Further, the method also includes assigning a weight factor to the at least one candidate application based on the bandwidth ratio. In addition, the method includes determining the target perceptual quality score for the at least one media stream of the at least one candidate application based on the perceptual quality score for the at least one media stream received from each application of the plurality of applications, the plurality of network parameters, the assigned weight factor to the at least one candidate application, and the bandwidth ratio.

In an embodiment of the disclosure, the plurality of the network parameters includes at least one of a network bandwidth, network congestion, a network quality of service (QoS) identifier, the XR device capability and capability of XR device, capability of at least one server from which the at least one stream is received, and latency requirements.

In an embodiment of the disclosure, the determining of the perceptual quality score for the at least one media stream received from each application of the plurality of applications includes determining, the at least one media parameter of at least one media stream received from each application of the plurality of applications, and the plurality of XR parameters. Further, determining the perceptual quality score for the at least one media stream received from each application of the plurality of applications based on the at least one media parameter and the plurality of XR parameters.

In an embodiment of the disclosure, the plurality of XR parameters includes a XR rendering space, and user preferences in the XR rendering space, and wherein the user preferences in the XR rendering space includes a position of the user in the XR rendering space, user's observation axis in the position of the user in the XR rendering space, user's observation range in the position of the user in the XR rendering space, and user's field of view or focus in the position of the user in the XR rendering space.

In an embodiment of the disclosure, the harmonizing of the at least one media parameter of the at least one media stream received from the at least one candidate application based on the target perceptual quality score includes determining whether a capability of the XR device meets a capability threshold, the XR device has service negotiation capability, and the XR device has strict latency requirement. Further, performing one of harmonizing the at least one media parameter of the at least one media stream received from the at least one candidate application using an enhance content harmonizer, when the capability of the XR device meets the capability threshold, the XR device has service negotiation capability, and the strict latency requirement of the XR device is not strict, harmonizing the at least one media parameter of the at least one media stream received from the at least one candidate application using an On-Device content harmonizer, when the capability of the XR device meets the capability threshold, the XR device does not has service negotiation capability, and the strict latency requirement of the XR device is not strict. In addition, harmonizing the at least one media parameter of the at least one media stream received from the at least one candidate application using a service level content harmonizer, when the capability of the XR device does not meets the capability threshold, the XR device does not has service negotiation capability, and the strict latency requirement of the XR device is strict.

In an embodiment of the disclosure, the harmonizing of the at least one media parameter of the at least one media stream received from the at least one candidate application using the enhance content harmonizer includes transmitting a stream renegotiation request to at least one server associated with the at least one candidate application for harmonization of the at least one media stream, wherein the stream renegotiation request the target perceptual quality score required for the at least one stream of the at least one candidate application. Further, receiving a stream renegotiation response from the at least one server associated with the at least one candidate application accepting the harmonization of the at least one media stream. Thereafter, upscaling or downscaling, the at least one media parameter of the at least one media stream received from the at least one candidate application based on the target perceptual quality score when the stream renegotiation response is received from the at least one server, wherein the at least one media parameter of the at least one media stream received from the at least one candidate application is harmonized to change the perceptual quality score of the at least one candidate application to the target perceptual quality score.

In an embodiment of the disclosure, the harmonizing of the at least one media parameter of the at least one media stream received from the at least one candidate application using the on-device content harmonizer includes upscaling or downscaling, by the XR device, the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score.

In an embodiment of the disclosure, the harmonizing, by the XR device, of the at least one media parameter of the at least one media stream received from the at least one candidate application using the service level content harmonizer includes transmitting a stream renegotiation request to at least one server associated with the at least one candidate application for harmonization of the at least one media stream, wherein the stream renegotiation request includes at least one media parameter which needs to be modified for the at least one stream of the at least one candidate application. Further, receiving a stream renegotiation response from the at least one server associated with the at least one candidate application accepting the modification of the at least one media parameter of the at least one media stream of the at least one candidate application. Thereafter, modifying, by the at least one server, the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score. Furthermore, sending the at least one upscaled or downscaled media stream associated with the at least one candidate application to the XR device. Finally, rendering the at least one upscaled or downscaled media stream associated with the at least one candidate application.

In accordance with another aspect of the disclosure, an XR device of harmonizing perceptual quality of multiple applications in an XR environment is provided. The XR device includes one or more processors, a content harmonizer, and memory storing one or more computer programs including computer-executable instructions that, when executed by the one or more processors, cause the XR device to initially receive at least one media stream received from each application of a plurality of applications available in the XR device, determine a perceptual quality score for at least one media stream received from each application of the plurality of applications, determine at least one candidate application with different media quality from the plurality of applications based on the perceptual quality score for the at least one media stream received from each application of the plurality of applications, determine a target perceptual quality score for the at least one media stream of the at least one candidate application based on the perceptual quality score for the at least one media stream received from each application of the plurality of applications and a plurality of network parameters, and harmonize at least one media parameter of the at least one media stream received from the at least one candidate application based on the target perceptual quality score.

In accordance with another aspect of the disclosure, one or more non-transitory computer-readable storage media storing computer-executable instructions that, when executed by one or more processors of an XR device, cause the XR device to perform operations are provided. The operations include receiving, by the XR device, at least one media stream received from each application of a plurality of applications available in the XR device, determining, by the XR device, a perceptual quality score for at least one media stream received from each application of the plurality of applications, determining, by the XR device, at least one candidate application with different media quality from the plurality of applications based on the perceptual quality score for the at least one media stream received from each application of the plurality of applications, determining, by the XR device, a target perceptual quality score for the at least one media stream of the at least one candidate application based on the perceptual quality score for the at least one media stream received from each application of the plurality of applications, capability of XR device and a plurality of network parameters, and harmonizing, by the XR device, at least one media parameter of the at least one media stream received from the at least one candidate application based on the target perceptual quality score.

Other aspects advantages, and salient features of the disclosure will become apparent to those skilled in the art from the following detailed description, which, taken in conjunction with the annexed drawings discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1A is a representation of using multiple applications in an extended reality (XR) device according to an embodiment of the disclosure;

FIG. 1B is a representation of using multiple applications in an XR environment according to an embodiment of the disclosure;

FIG. 2A is a block diagram illustrating an XR device for harmonizing perceptual quality of multiple applications in an XR environment according to an embodiment of the disclosure;

FIG. 2B is a block diagram illustrating a content harmonizer for harmonizing perceptual quality of multiple applications in an XR environment according to an embodiment of the disclosure;

FIG. 3 is a block diagram illustrating a flow of harmonizing perceptual quality of media streams received from two applications used in XR device simultaneously according to an embodiment of the disclosure;

FIG. 4 is a sequence diagram illustrating a method of harmonizing perceptual quality of multiple applications in an XR environment according to an embodiment of the disclosure;

FIGS. 5A and 5B are flow diagrams illustrating a method of harmonizing perceptual quality of media streams received from multiple applications used in XR device according to various embodiments of the disclosure;

FIG. 6A is a block diagram illustrating a XR baseline architecture for service level content harmonization of perceptual quality of multiple media streams received from multiple applications according to an embodiment of the disclosure;

FIG. 6B is a block diagram illustrating perceptual quality score calculation of media streams received by multiple applications by a score generator module for harmonizing perceptual quality of multiple applications according to an embodiment of the disclosure;

FIG. 6C is a block diagram illustrating a perceptual quality score generation of media streams for multiple applications by a feature calibrator and feature assessor associated with a score generator module according to an embodiment of the disclosure;

FIG. 6D is a block diagram illustrates a target score evaluator for generating target perceptual quality score and harmonizing a media stream received from multiple applications according to an embodiment of the disclosure;

FIG. 7A is a block diagram illustrating a XR baseline architecture during on-device content harmonization of perceptual quality of multiple media streams received from multiple applications according to an embodiment of the disclosure;

FIG. 7B is a block diagram illustrating perceptual quality score calculation of media streams received by multiple applications by a score generator module for harmonizing perceptual quality of multiple applications according to an embodiment of the disclosure;

FIGS. 7C, 7D, 7E, and 7F are block diagrams illustrating a perceptual quality score generation of media streams for multiple applications by a feature calibrator and feature assessor associated with a score generator module according to various embodiments of the disclosure;

FIG. 7G is a schematic block diagram illustrating a target score evaluator for generating target perceptual quality score and harmonizing a media stream received from multiple applications according to an embodiment of the disclosure;

FIG. 8A is a block diagram illustrating a XR baseline architecture for combination of on-device and service level content harmonization of perceptual quality of multiple media streams received from multiple applications according to an embodiment of the disclosure;

FIG. 8B is a block diagram illustrating perceptual quality score calculation of media streams received by multiple applications by a score generator module for harmonizing perceptual quality of multiple applications according to an embodiment of the disclosure;

FIGS. 8C, 8D, 8E, and 8F are block diagrams illustrating a perceptual quality score generation of media streams for multiple applications by a feature calibrator and feature assessor associated with a score generator module according to various embodiments of the disclosure;

FIG. 8G is a schematic block diagram illustrating both an on-device content harmonization and service level harmonization of perceptual quality of media streams of multiple applications by a score harmonizer according to an embodiment of the disclosure;

FIGS. 9A, 9B, and 9C illustrate scenarios of harmonizing perceptual quality of media streams received from plurality of applications in an XR environment according to various embodiments of the disclosure; and

FIG. 10 is a flow diagram illustrating a method of harmonizing perceptual quality of multiple applications in an XR environment according to an embodiment of the disclosure.

Throughout the drawings, like reference numerals will be understood to refer to like parts, components, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalent.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

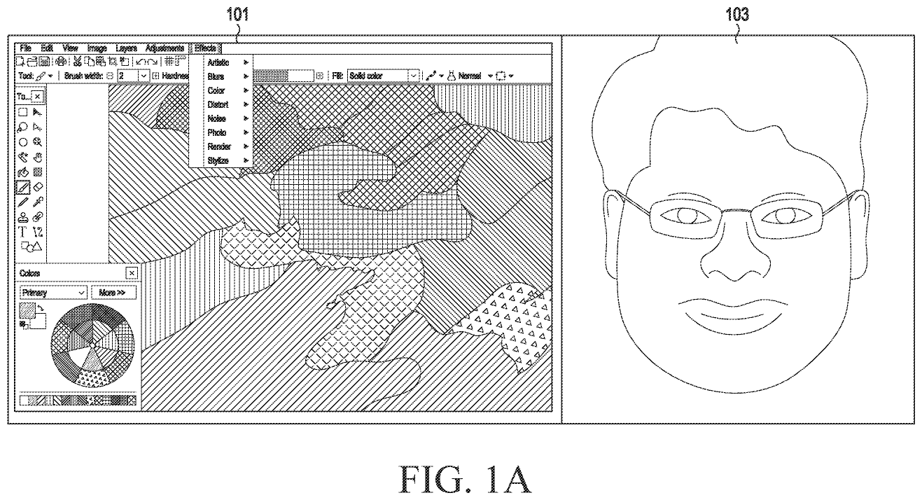

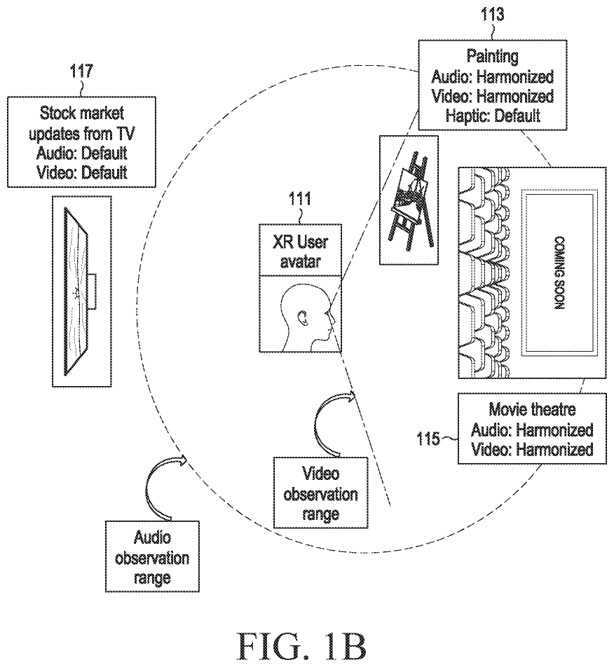

FIG. 1A is a representation of using multiple applications in an XR device according to an embodiment of the disclosure.

In existing system, multiple applications may be used simultaneously in a XR device. For example, referring to FIG. 1A there may be two applications used in the XR device simultaneously. One of the applications is a painting application 101 displayed on the left-hand side of the XR device and a calling application 103 in which the users face is displayed on the right-hand side of the XR device simultaneously. Further consider the painting application video is displayed at 8K resolution and the calling application video is displayed at VGA resolution (640*480). As a result, the painting application is viewed with higher resolution and the video calling applications is viewed at much lower resolution when compared to the painting application. Thus, both the painting application and the video calling application is displayed at two different resolutions. Thus, the varying quality between two applications on the XR device reduces the user experience and further reduces the impressiveness of the user with the XR device.

FIG. 1B is a representation of using multiple applications in an XR environment according to an embodiment of the disclosure.

Referring to FIG. 1B, consider a user 111 in an XR environment is using three applications simultaneously. Consider the user 111 is using three applications, such as painting application 113, movie theatre 115 and television (TV) application 117. Further, in the scenario as shown in FIG. 1B the user is looking towards both the movie theatre and painting applications and also both the painting application and XR theatre application is present closer to the XR environment. However, the TV application is not within the audio range and video range of the user 111. Moreover, the user 111 is able to view the painting application 113 with higher resolution and the movie application 115 with the lesser resolution when compared to that of the painting application 113. The user 111 is viewing uneven quality between the painting application and the movie theatre application, since the painting application and the movie theatre application is receiving the painting data and movie data respectively from two different servers. The uneven quality between the streams makes the user 111 annoy and leads to the reduction in the user experience. Further, the sudden changes in perceptual quality is distracting to the user and leads to unwilling eye movements and refocusing which results in reduction of quality of experience (QoE). In addition, the uneven rendering of the media streams leads to reduced immersiveness in the XR environment. Thus, there is a need for harmonizing the perceptual quality of multiple media streams running simultaneously the in XR environment.

In the proposed method, the uneven perceptual quality of media streams received from multiple applications are harmonized. The harmonization is performed by determining a perceptual quality score for at least one media stream received from multiple applications used in the XR device. Further, a target perceptual score is determined based on the determined perceptual quality score of the media streams received from multiple applications and network parameters. Finally, media parameters of at least one media stream is harmonized based on the target perceptual quality score. Thus, the harmonization of the media streams of multiple applications used in the XR device provides an even perceptual quality of media streams of multiple applications. Hence providing a seamless and smooth experience to the users while using multiple applications in the XR device.

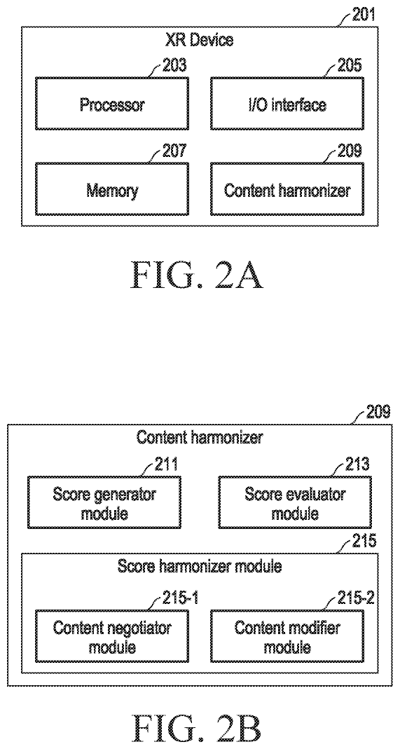

FIG. 2A is a block diagram illustrating an XR device 201 for harmonizing perceptual quality of multiple applications in an XR environment according to an embodiment of the disclosure.

Referring to FIG. 2A, the XR device 201 includes a processor 203, an input/output (I/O) interface 205, memory 207 and a content harmonizer 209. The XR device 101 is a head mounted displays (HMD). In AR, the HMD superimposes digital information with the real-world objects. In addition, in VR the display of HMD is not transparent and only the virtual information and images are displayed in front of wearers eyes.

Further, the processor 203 of the XR device 201 communicates with the memory 207, the I/O interface 205 and a content harmonizer 209. The processor 203 is configured to execute instructions stored in the memory 207 and to perform various processes. The processor 203 may include one or a plurality of processors, can be a general-purpose processor, such as a central processing unit (CPU), an application processor (AP), or the like, a graphics-only processing unit, such as a graphics processing unit (GPU), a visual processing unit (VPU), and/or an Artificial intelligence (AI) dedicated processor, such as a neural processing unit (NPU).

The memory 207 of the XR device 201 includes storage locations to be addressable through the processor 203. The memory 207 is not limited to volatile memory and/or non-volatile memory. Further, the memory 207 may include one or more computer-readable storage media. The memory 207 may include non-volatile storage elements. For example, non-volatile storage elements may include magnetic hard discs, optical discs, floppy discs, flash memories, or forms of electrically programmable read only memories (EPROMs) or electrically erasable and programmable ROMs (EEPROMs). The memory 207 may store the media streams, such as audios stream, video streams, haptic feedbacks and the like.

The I/O interface 205 transmits the information between the memory 207 and external peripheral devices. The peripheral devices are the input-output devices associated with the XR device 201. The I/O interface receives several information from at least one of sensors, cameras, actuators, displays, speakers and microphones associated with the XR device 201.

The content harmonizer 209 of the XR device 201 communicates with the processor 203, I/O interface 205 and memory 207 to harmonize the perceptual quality of the media streams of multiple applications running simultaneously in the XR device 201. Initially, the content harmonizer 209 receives at least one media stream from each applications application among plurality of application running simultaneously in the XR device 201. As per 3GPP spec 22.856, there is a provision in the XR device 201 for supporting multiple applications to run simultaneously and allow the user to view and interact with multiple applications concurrently. For example, the XR device 201 may run multiple applications, such as painting application, gaming applications, healthcare applications and the like. Each of the applications can be associated with multiple media streams where the media stream represents a stream of media content. For example, some of the media stream includes, but not limited to at least one of audio stream, video stream, haptics, and 3D content.

Upon receiving, the content harmonizer 209 determines a perceptual quality score for at least one media stream received from each application of the plurality of applications. The perceptual quality score is a score which represents the media quality perceived by the user while using multiple applications in the XR device 201. In some embodiments of the disclosure, the perceptual quality score is a score which denotes the extent of influence of media parameters or metrics on the perceptual quality of the media content. The content harmonizer 209 determines the perceptual quality score for each of the media stream associated with multiple applications running in the XR device 201. The content harmonizer 209 determines the perceptual quality score using at least one of techniques, such as universal video quality (UVQ), media opinion score network (MOSNet), and the like. More particularly, the UVQ can be used to determine the perceptual quality of the video and MOSNet may determine the perceptual quality score for audio. For example, consider, a painting application and a movie application is running in the XR device 201 simultaneously. The painting application comprises media streams, audio streams and the haptic streams. Similarly, the movie application comprises the audio stream and the video stream. Further, the content harmonizer 209 determines the perceptual quality scores of audio stream, video stream and haptics streams of the painting applications and also determines the perceptual quality score for each of the audio stream and video stream of the movie application.

Furthermore, the content harmonizer 209 determines at least one candidate application with different media quality from plurality of applications based on the determined perceptual quality score of media streams received from each of the application. The content harmonizer 209 determines the candidate application among the plurality of applications running in the XR device 201 based on the determined perceptual quality score. The candidate application is the application which is having different perceptual quality score of the media stream with respect to the perceptual quality score of the media stream associated with other applications. For example, consider the multiple applications, such as video call application, movie applications, and painting application running in the XR device. Further, the perceptual quality score of the audio stream received from movie application and painting application is having similar value. However, the perceptual quality score of the video stream received from the movie application is different from that of the video stream received from the painting application. The movie application may have a less perceptual score for the video stream when compared to that of the perceptual quality score of video stream associated with the painting application. Thereafter, the content harmonizer 209 decides the candidate applications being the movie application, since the perceptual quality scores for the video streams is lesser and requires harmonization with painting application.

Thereafter, the content harmonizer 209 determines a target perceptual quality score for the at least one media stream of the at least one candidate application based on the determined perceptual quality score of the media streams and the plurality of network parameters. The target perceptual quality score is a score which represents the media quality that is required by the candidate application to harmonize with the other application. The target perceptual quality score is determined based on the perceptual quality score of the media streams of the candidate application and the network parameters associated with the candidate application. The network parameters may include at least one of network bandwidth, network congestion, a network quality of service (QoS) identifier, the XR device capability, latency requirement and the capability of at least one server from which the candidate application is receiving the media streams.

Finally, the content harmonizer 209 harmonizes the at least one media parameter of media stream received from the candidate application based on the target perceptual quality score. The media parameters include, but not limited to, a bit rate, a codec, a brightness, a frame complexity, a sample rate, a channel count, a pitch and a frame rate. Thus, the content harmonizer 209 harmonizes the at least one of media parameter of media stream received from candidate application with the media parameter of the media stream received from the other applications running simultaneously in the XR device 201. Hence, the content harmonizer 209 provides an even perceptual quality of media streams of multiple applications which results in a seamless and smooth experience to the users while using multiple applications in the XR device 201.

FIG. 2B is a block diagram illustrating a content harmonizer for harmonizing perceptual quality of multiple applications in an extended reality (XR) environment according to an embodiment of the disclosure.

Referring to FIG. 2B, the content harmonizer 209 comprises a score generator module 211, a score evaluator module 213 and a score harmonizer module 215. Further the score harmonizer module 215 includes a content negotiator module 215-1 and a content modifier module 215-2.

Initially, the score generator module 211 of the content harmonizer 209 is configured to generate the perceptual quality score for each of the media stream received from multiple applications running in the XR device 201. The perceptual quality score is a score which denotes the extent of influence of media parameters or metrics on the perceptual quality of the media content. In addition, the perceptual quality score is a subjective score generated by media content and parameter-based assessment which can be used for comparison across applications. The score generator module 211 assesses and generates a perceptual quality score for each media stream received from plurality of applications running simultaneously in the XR device 201. The score generator module 211 initially extracts media parameters of each of the media stream received from plurality of applications running simultaneously in the XR device 201. The media parameters can be extracted using the media feature extractor. Further, the score generator module 211 generates a calibration table based on the extracted media parameters. The calibration table represents the information indicating the impact of individual media parameters on the quality of the media streams. The calibration table for the media stream can be determined using an AI model to determine the impact of media parameters for varying the quality of content. For example, the calibration table is <P1-5, P2-6, P3-9, P4-2>, where P1, P2, P3 and P4 indicates the media parameters and the numerical value represents the amount of impact of the metric on the media stream. It is observed that for the above calibration table the parameter 3 (P3) has the highest impact on the quality of the media stream and P4 has the lowest impact on the quality of the media stream. Hence, it can be deduced that the change in the P3 will lead to the change in the quality of the media content. Further, the score generator module 211 generates a perceptual quality score for the media streams received from the plurality of applications. The score generator module 211 determines a subjective perceptual quality score vector based on the determined calibration table and the media streams received from the plurality of applications. The perceptual quality scores for the media streams can be generated using at least one of an universal video quality (UVQ) method, mean opinion score (MOSNet). For example, the score generator module 211 generates the perceptual quality score for each of the media stream, such as video stream, audio stream, haptics streams, and 3D objects streams based on the calibration table for each of the media streams and the media streams received from plurality of applications. In addition, the perceptual quality score may have the values ranging between 0-9, where 0 indicates the lowest impact or lowest quality and 9 indicates the highest quality or highest impact. In addition, the score generator module 211 determines the candidate application from the plurality of applications for which the perceptual quality score of media streams is different from each other.

The score evaluator module 213 of the content harmonizer 209 determines a target perceptual quality score based on the perceptual quality score of media streams received from candidate applications, the XR device 201 capability and the network information. The network information includes, but not limited to network bandwidth, network congestion, a network quality of service QoS identifier, capability of at least one server from which the at least one stream is received, and latency requirements. The target perceptual quality score is a weighted average of all the application scores, where the target perceptual quality score is determined using the below Equation 1:

$$Target perceptual quality Score = σ {W}_{i} Perceptual {qualityScore}_{i} / σ {W}_{i} where {W}_{i} is weight factor \qquad Equation 1$$

The weight factor is determined based on a bandwidth ratio, where the bandwidth ratio is a ratio of the bandwidth available to the bandwidth used. Further, if the bandwidth ratio is higher than a threshold, then the weight factor is directly proportional to the perceptual quality score. Similarly, if the bandwidth ratio is lower than a threshold, then the weight factor is inversely proportional to the quality score.

Upon determination of the target perceptual quality score, the score harmonizer module 215 harmonizes the media parameters of media streams received from candidate applications based on the target perceptual quality score. For example, consider the Video stream perceptual quality score of application 1 is V-4 and the video stream perceptual quality score of application 2 is V-8 and the target perceptual score is determined to be 7. The content modifier module 215-2 of the score harmonizer module 215 up samples the video stream perceptual quality score of application 1 to V-7 and makes no changes to the video stream perceptual quality score of application 2. Thus, ensuring even perceptual quality between application 1 and application 2. In some embodiments of the disclosure, the content negotiator module 215-1 of the score harmonizer module 215 renegotiates with server of the application 1 to render the video stream as per the determined target perceptual quality score.

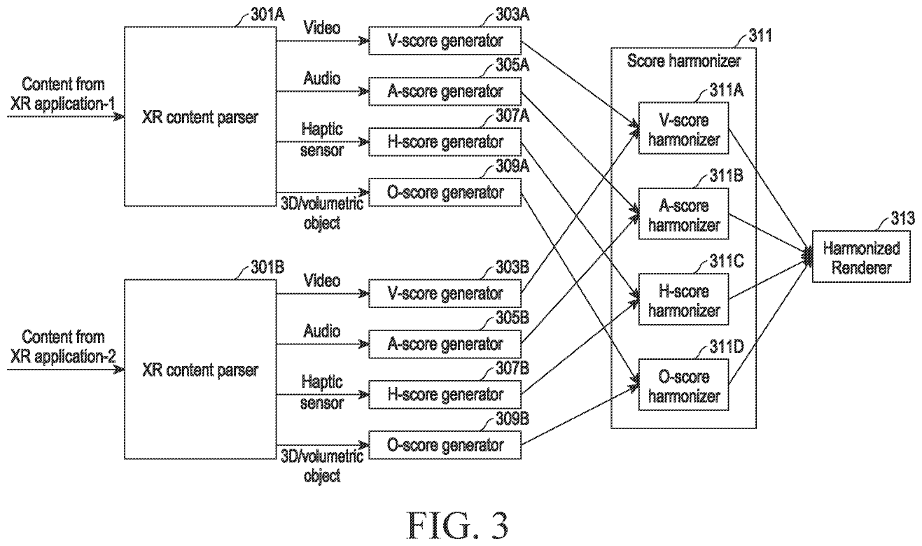

FIG. 3 is a block diagram illustrating a flow of harmonizing perceptual quality of media streams received from two applications used in XR device simultaneously according to an embodiment of the disclosure.

Referring to FIG. 3, consider, two applications namely application 1 and application 2 are used in the XR device 201 simultaneously. Further, the media content from application 1 and application 2 is received by the XR content parser 301A and 301B respectively. The XR content parser 301A parses and extracts the features of the media streams and determines the media parameters of the media streams received from the application 1. Similarly, the XR content parser 301B parses and extracts the features of the media streams and determines the media parameters of the media streams received from the application 2. Thereafter, the extracted media parameters of the respective video stream, audio stream, haptic sensor stream, 3D object streams of the application 1 are provided for the V-score generator 303A, A-score generator 305A, H-score generator 307A and O-score generator 309A respectively. Similarly, the extracted media parameters of the respective video stream, audio stream, haptic sensor stream, 3D object streams of the application 2 are provided for the V-score generator 303B, A-score generator 305B, H-score generator 307B and O-score generator 309B respectively. The V-score generator 303A, 303B generates the perceptual quality score of the video stream received from the application 1 and application 2 based on the calibration table determined for extracted video parameters of the video streams and user parameters in XR space and rendering space. For example, the video parameters include, but not limited to resolution, frame rate, bit rate, codec, luminance and frame complexity. In addition, the A-score generator 305A, 305B generates the perceptual quality score of the audio stream received from the application 1 and application 2 based on the based on the calibration table determined for extracted audio parameters of the audio streams and user parameters in XR space and rendering space. For example, the audio parameters include, but not limited to sample rate, pitch, codec, bitrate, and channel count. Further, the H-score generator 307A, 307B generates the perceptual quality score of the haptics stream received from the application 1 and application 2 based on the calibration table determined for extracted haptics parameters of the haptic streams and user parameters in XR space and rendering space. For example, the haptics parameters include, but not limited to sample rate, codec, and bit rate. Moreover, the O-score generator 309A, 309B generates the perceptual quality score of the 3D object stream received from the application 1 and application 2 based on the calibration table determined for extracted 3D object parameters of the 3D object streams and user parameters in XR space and rendering space. Upon the perceptual quality score generation, the score harmonizer 311 determines the target perceptual quality score for each of the video stream, audio stream, haptics stream and 3D object streams based on the perceptual quality scores of the video stream, audio stream, haptics stream and 3D object streams of the application 1 and application 2. More particularly, the V-score harmonizer 311A determines the target perceptual quality score of video stream based on the perceptual quality score of the video stream of application 1 and application 2 and the network parameters. Similarly, the A-score harmonizer 311B 1 determines the target perceptual quality score of audio stream based on the perceptual quality score of the audio stream of application 1 and application 2 and the network parameters. In addition, H-score harmonizer 311C determines the target perceptual quality score of haptics stream based on the perceptual quality score of the haptics stream of application 1 and application 2 and the network parameters. The O-score harmonizer 311D determines the target perceptual quality score of 3D object stream based on the perceptual quality score of the 3D object stream of application 1 and application 2 and the network parameters. Upon the generation of target perceptual quality score for each of the media stream, the harmonizer renderer 313 harmonizes the perceptual quality score of either the media streams received from application 1 or media streams received from application 2 based on the target perceptual quality score of at least one media stream. For example, consider the perceptual quality of the video stream of application 1 needs to be harmonized. In such cases, the harmonizer renderer 313 re-negotiates with the server associated with application 1 to render video stream based on the target perceptual quality score of video stream, such that the perceptual quality of application 1 and application 2 is similar. In some embodiments of the disclosure, the harmonizer renderer 313 modifies the perceptual quality scores of the video parameter of video stream based on the target perceptual quality score of video stream to harmonize the perceptual quality of video streams received from application 1 and application 2.

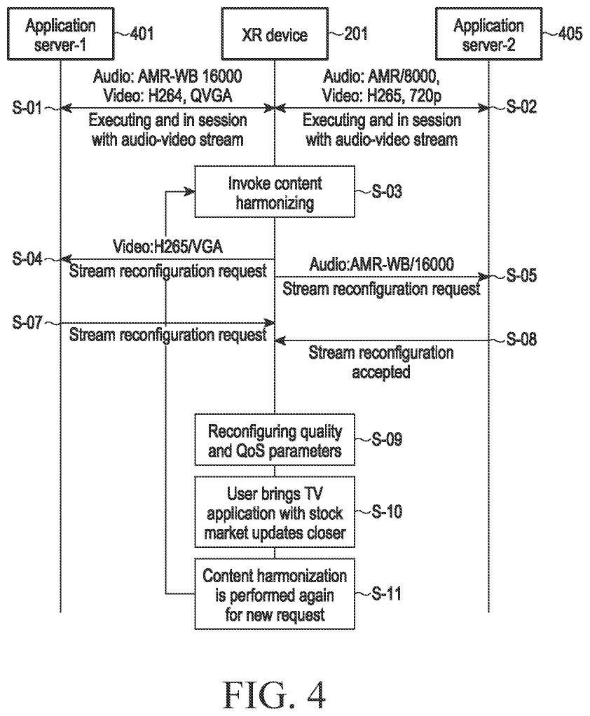

FIG. 4 is a sequence diagram illustrating a method of harmonizing perceptual quality of multiple applications in an extended reality (XR) environment according to an embodiment of the disclosure.

Referring to FIG. 4, a XR device 201 is using two applications namely application 1 and application 2 simultaneously.

Initially at operation S-01, the content of the application-1 running in the XR device 201 is received from an application server-1 401. The media content received from application server-1 401 comprises audio content and video content, where the audio content is received at XR device 201 from application server-1 401 is having codec value as AMR-WB 16000 and the video content received at the XR device 201 from the application server-1 401 is having a resolution of H264, QVGA.

At operation S-02 the content of application-2 running in the XR device 201 is received from an application server-2 405. The media content received from application server-2 also comprises a video content and an audio content. The video content from the application server-2 405 received at the XR device 201 is having a resolution value of H265, 720p. In addition, the audio content from the application server-2 405 received at the XR device 201 is having a codec value of AMR/8000.

At operation S-03, a content harmonization of the media contents received from application server-1 401 and application server-2 405 is invoked, when the perceptual quality score of the media content received from application server-1 401 is different from that of the perceptual quality score of the media content received from the application server-2 405. Further, a target perceptual quality score is determined based on the perceptual quality scores of the media content received from application server-1 401 and application server-2 405 and network parameters of the communication network between the XR device 201, application server-1 401 and application server-2 405.

At operation S-04, the XR device 201 transmits a stream configuration request to application server-1 401 for rendering the video content with a resolution H265/VGA (target perceptual quality score).

In addition, at operation S-05, the XR device 201 transmits a stream configuration request to application server-2 405 for rendering the audio content with a codec value AMR-WB/16000 (target perceptual quality score).

Further at operation S-07, the application server-1 401 accepts the stream reconfiguration request and renders the requested video content with a resolution H265/VGA to the XR device 201.

Similarly, at operation S-08, the application server-2 405 accepts the stream reconfiguration request and renders the requested audio content with a codec AMR-WB/16000 to the XR device 201.

At operation S-09, the XR device 201 reconfigures the quality and QoS parameters based on the rendered video content and audio content received from application server-1 401 and application server-2 405 respectively.

At operation S-10, the XR device 201 is able to view both the application 1 and application 2 with similar perceptual quality.

At operation S-11, the user device 201 invokes the content harmonization when a new application starts running in the XR device 201.

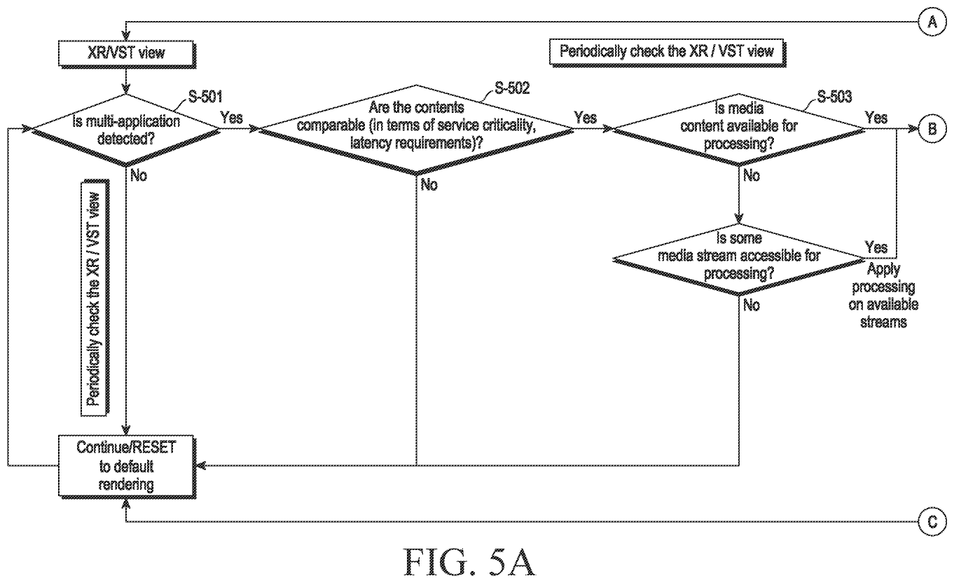

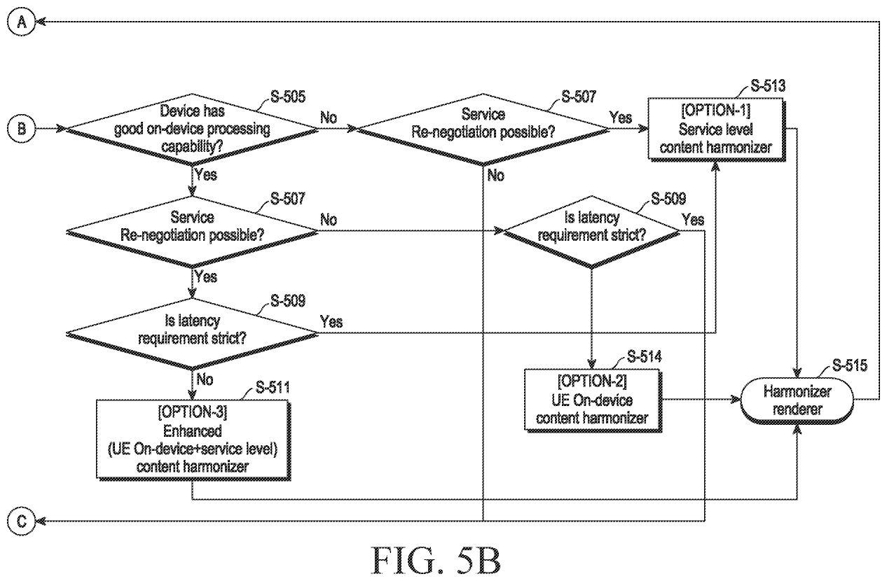

FIGS. 5A and 5B are flow diagrams illustrating a method of harmonizing perceptual quality of media streams received from multiple applications used in XR device according to various embodiments of the disclosure.

Referring to FIGS. 5A and 5B, the perceptual quality of media streams received from multiple applications is harmonized by determining whether the XR device meets a capability threshold, the XR device has service negotiation capability and the XR device has strict latency requirement.

In an embodiment of the disclosure, at operation S-501, the content harmonizer 209 detects if there are multiple applications running in the XR device 201. The XR device 201, continues to render the application content from an application server without harmonization when only one application is running in the XR device 201.

Upon detecting that multiple applications are running in the XR device 201, the content harmonizer 209 at operation S-502 further determines if the media contents of the multiple applications are comparable in terms of service criticality, latency requirements and the like. When the media contents of the multiple applications are determined to be comparable, then at operation S-503, the content harmonizer 209 determines if some media stream is accessible for processing. And, when the media stream is determined to be not accessible then media content continues to render the application content from an application server without harmonization.

However, when the media stream is determined to be available and accessible for processing, then at operation S-505 the content harmonizer 209, determines whether the XR device 201 has good on-device processing capability.

When the XR device 201 is determined to have a good on-device processing, at operation S-507, the content harmonizer 209 further determines whether a service renegotiation is possible. When the service re-negotiation is determined to be possible, at operation S-509 the content harmonizer 209 further determines whether the latency requirement is strict or not.

Furthermore, when the latency requirement is determined to be not strict, then at operation S-511 the content harmonizer 209 performs a combination of on-device content harmonization and service level content harmonization.

In some embodiments of the disclosure, when the service re-negotiation is determined to be not possible at operation S-507 and if the latency requirement is determined to be strict at operation S-509, then the content harmonizer 209 does not perform the content harmonization and simply renders the media content received from the application servers.

Furthermore, when the service re-negotiation is determined to be not possible at operation S-507 and when the latency requirement is determined to be not strict at operation S-509, then at operation S-514 the content harmonizer 209 performs an on-device content harmonization.

In addition, when the XR device 201 is determined to not have a good on-device processing capability at operation S-505, and service re-negotiation is possible at operation S-507, then at operation S-513, the content harmonizer 209 performs a service level content harmonization.

Finally, at operation S-515, the harmonized renderer 313 will render the requested media content for the applications running in the XR device 201.

Hence, the content harmonizer 209 applies different content harmonization on the media content based on different policy, device capability and the server capability. The different policies may include but not limited to a latency policy for the application and criticality policy for the application.

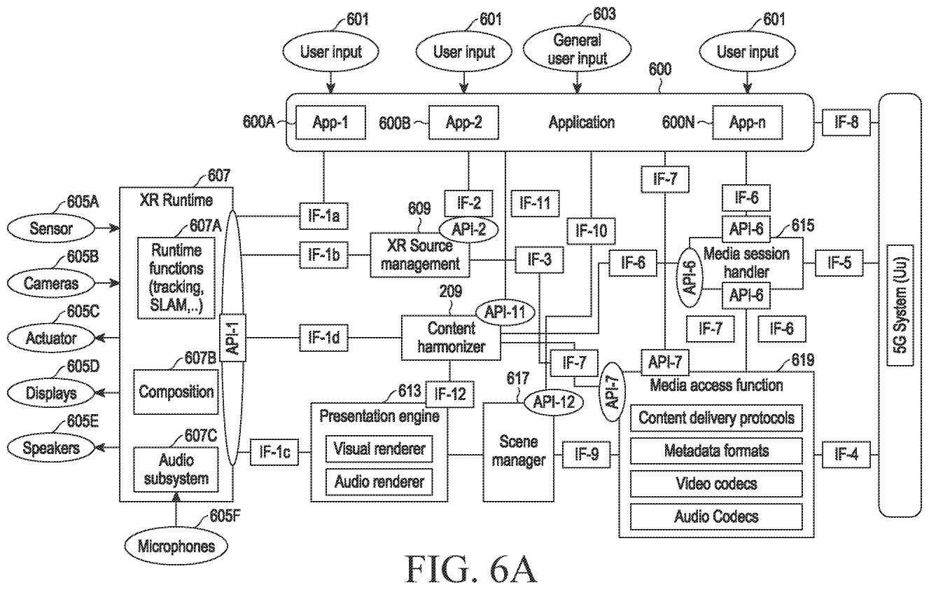

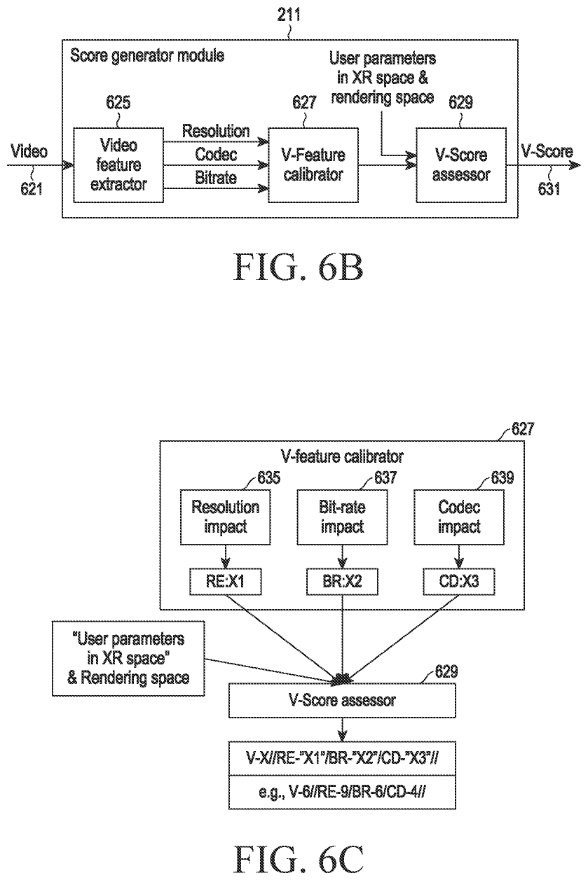

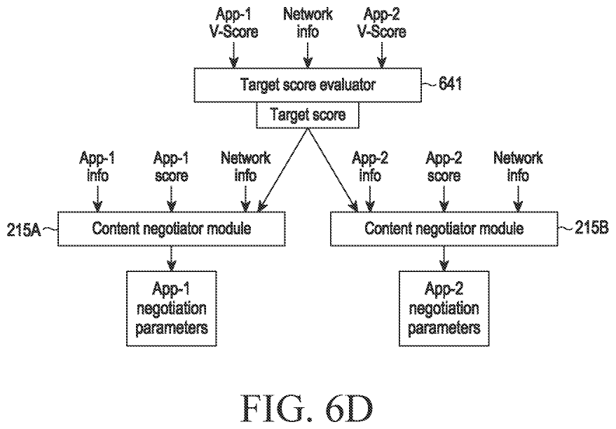

FIG. 6A is a block diagram illustrating an XR-baseline architecture for providing service level content harmonization of perceptual quality of multiple media streams received from multiple applications according to an embodiment of the disclosure.

Referring to FIG. 6A, consider, multiple application, such as application 1 600A, application 2 600B . . . application n 600N are running on the XR device 201. The multiple applications receive a multiple user input 601 or a general user input 603 from the user using the XR device 201. For example, the multiple user input may include but not limited to a user motion, speech, and gesture commands. The XR application 600 serializes multiple user input requests before forwarding for the further processing.

Further, the XR device 201 receives inputs from one or more devices associated with the XR-device 201. The one or more devices associated with the includes, but not limited to sensors 605A, cameras 605B, actuators, 605C, displays 605D, speakers 605E and microphones 605F. Further, the inputs received from one or more devices associated with the XR device 201 can be pre-processed in a XR runtime 607. In some embodiments of the disclosure, the XR runtime 607 receives user inputs from multiple applications through the XR source management 609. The XR source management 609 serializes multiple user inputs 601—before transmitting to the XR runtime 607 for further processing.

The XR-runtime 607 provide data parallelly to all registered applications, e.g., if multiple application registers to get position tracking information, then XR Runtime may give that information parallelly to all registered applications.

For example, sensor data captured by sensor 605A, image data captured by cameras 605B are processed using some of the runtime functions 607A, such as tracking techniques, simultaneous localization and mapping (SLAM) techniques and the like. In some embodiments of the disclosure, the XR runtime functions 607A may receive the user input 601 from the application-1 600A for further processing through an interface IF-1a associated with API-1. Similarly, the data displayed on the displays 605D can be processed or modified using some of the composition techniques 607B and audio content received from speakers 605E and microphones 605F can be processed though audio subsystems 607C using audio processing techniques.

Further the XR runtime 607 communicates with XR source management 609 through an interface IF-1b. The XR source management 609 serializes requests from multiple applications 600A, 600B, 600N before forwarding it to XR Runtime 607. It also parallelizes multiple application data which will be sent in the uplink. In addition, the XR runtime 607 communicates with the XR-content harmonizer 611 through an interface IF-1d associated with API-1 and presentation engine 613 through an interface 1F-1c associated with API-1.

The content harmonizer 209 performs a service level content harmonization for the media streams received from multiple applications 600A, 600B, . . . 600N received through interface IF-11 associated with the application programming interface (API-11), data received from the XR runtime 607. The content harmonizer 209 comprises three sub-modules namely a score generator module 211, the score evaluator module 213 and a content negotiator module 215A. The score generator module 211 extracts at least one media parameter of each of the media stream received from multiple applications 600A, 600B, . . . 600N.

FIG. 6B is a block diagram illustrating a score generator module 211 for determining perceptual quality score of media streams received by multiple applications for service level harmonization according to an embodiment of the disclosure.

Referring to FIG. 6B, the score generator module 211 initially extracts, using a video feature extractor 625, the video parameters of the video streams 621 received from multiple applications features. For example, consider the video parameters extracted by the video feature extractor 625 includes, but not limited to a resolution of the video stream, codec of the video stream and bit rate of the video stream.

FIG. 6C is a block diagram illustrating a perceptual quality score generation of media streams for multiple applications by a feature calibrator and feature assessor associated with a score generator module according to an embodiment of the disclosure.

Referring to FIG. 6C, the V-feature calibrator 627 generates a calibration table which indicates the impact of each video parameter on the perceptual quality of the video stream. The calibration table is generated using the V-feature calibrator 627 as shown in FIG. 6C. The V-feature calibrator 627 generates a calibration table, which indicates the impact of each video parameter of at least one video stream received from multiple applications. The V-feature calibrator 627 may use a trained AI model to determine the impact of each video parameter on the at least one video stream received from multiple applications. The AI model determines the impact of the video parameters by modifying each video parameters value and analysing the impact based on some of the perceptual metrics. For example, the perceptual metrics may include but not limited to a Mel-frequency cepstral coefficients (MFCC)/chroma for audio, and content complexity for video. Consider an example, as shown in FIG. 6C, the impact of resolution parameter 635 is X1, indicated as RE:X1, the impact of bit-rate 637 is X2, indicated as BR:X2, and the impact of codec 639 is X3, indicated as CD:X3. Upon determining the impact of each video parameter, the V-score assessor 629 generates a perceptual quality score for the video stream (V-score 631) based on the impact of each video parameter determined for the video stream and XR parameters. The XR parameters may include, but not limited to XR rendering space, and user preferences in XR rendering space. The user preferences in XR rendering space may include, but not limited to position of the user in the XR rendering space, user's observation axis in the position of the user in the XR rendering space, user's observation range in the position of the user in the XR rendering space, and user's field of view or focus in the position of the user in the XR rendering space. The v-score 631 generated by the V-score assessor 629 can be represented as “V-X//RE-“X1”/BR-“X2”/CD-“X3”//”, where the perceptual quality score of the video stream received from an application is having a value “X”, which is determined based on the value X1, X2 and X3. The scores for each metric and perceptual quality may have a value ranging between 0-9. For example, consider the v-score 631 generated based on the impact of video parameters value is as shown below: V-6//RE-9/BR-6/CD-4.

FIG. 6D is a block diagram illustrates a target score evaluator for generating target perceptual quality score and harmonizing a media stream received from multiple applications according to an embodiment of the disclosure.

Referring to FIG. 6D, upon generation of perceptual quality score (V-score), a target score is generated by a target score evaluator 641. The target score evaluator 641, receives the perceptual quality scores generated for the media stream received from at least one application and plurality of network parameters. Further, the target score evaluator 641 generates the target perceptual quality score for the media stream received from at least one application. The network parameters may include but not limited to network bandwidth, network congestion, a network quality of service (QoS) identifier, the XR device capability and capability of XR device, capability of at least one server from which the at least one stream is received, and latency requirements.

For example, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.7. The bandwidth ratio is ratio between the available bandwidth and the bandwidth used. For the bandwidth ratio being 1.7, consider the corresponding weight factor is 3 for application 1 and 7 for application 2.

$$The target perceptual quality score = ( 3 * 4 + 7 * 8 ) / ( 3 + 7 ) = 6.8 = ∼ 7 .$$

In some embodiments of the disclosure, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.1. The bandwidth ratio is ratio between the available bandwidth and the bandwidth used. For the bandwidth ratio being 1.7, consider the corresponding weight factor is 7 for application 1 and 3 for application 2.

$$Target perceptual quality Score = ( 7 * 3 + 3 * 8 ) / ( 3 + 7 ) = 4.5 = ∼ 5$$

Upon the generation of the target perceptual quality score, the content negotiator module 215A renegotiates with a server for modifying the media parameters of the media streams based on the target perceptual quality score. For example, consider for the target perceptual quality score having a value of 7, the content negotiator module 215A renegotiates with the server of the application 1 for renegotiating the resolution and bitrate value such that the V-score is modified from 4 to 7. In addition, the content negotiator module 215A renegotiates with the server of the application 2 for renegotiating the bitrate to a lower value to free up some bandwidth such that the V-score is reduced from 8 to 7.

Similarly, consider the target perceptual score having a value 5, the content negotiator module 215A renegotiates with server of the application 1 for renegotiating the bitrate value to modify the V-score from 4 to 5. In addition, the content negotiator module 215A renegotiates with the server of the application 2 for renegotiating the resolution and bitrate to a lower value to free up some bandwidth to reduce the V-score from 8 to 5.

Upon the content harmonization, the content harmonizer 209 communicates with a media session handler 615 through an interface IF-6 associated with the application programming interface (API-6). The media session handler 615 offers tools for content harmonizer 209 to negotiate media parameters for providing similar quality in multiple applications running to the users. The media session handler 615 further communicates with fifth-generation (5G) to establish, control and support the delivery of a media session through an interface IF-5. Furthermore, the content harmonizer 209 communicates with a scene manager 617 through an interface IF-12 associated with API-12. The scene manager 617 renders multiple media streams which in the user's observation range. In addition, the scene manager 617 performs the occlusion control. The scene manager 617 helps multiple applications in arranging the logical and spatial representation of a multisensory scene based on support from the XR Runtime 607 and XR Content manager 611. The IF-12 is realized through an API (API-12). In addition, the content harmonizer 209 communicates with a media access function 619 through an interface IF-7 associated with API-7. The IF-7 helps XR Content manager/content harmonizer 209 to get media content of multiple applications from media access function 619. Finally, the media access function 619 enables access to media streams to be communicated through the 5G system over an interface IF-4.

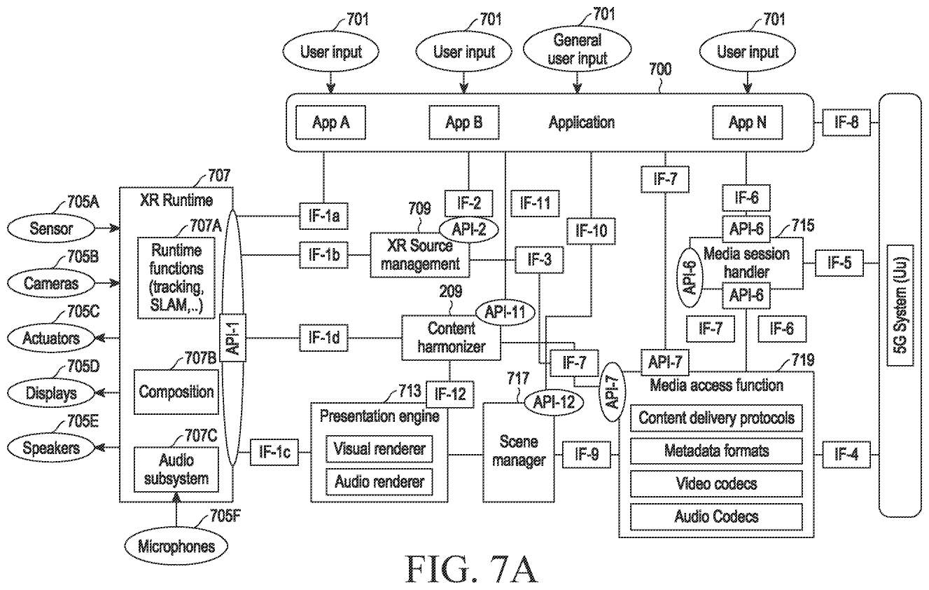

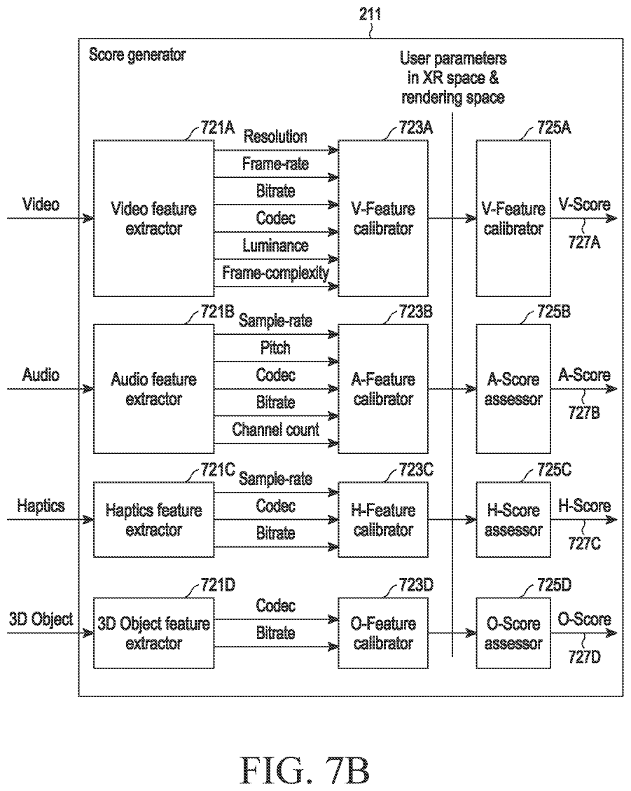

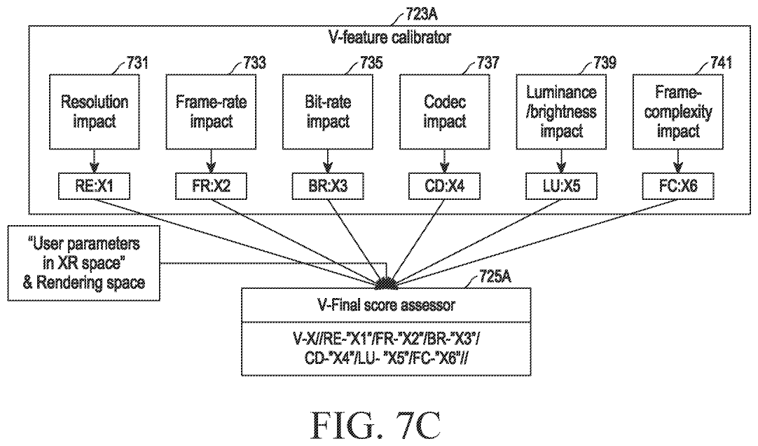

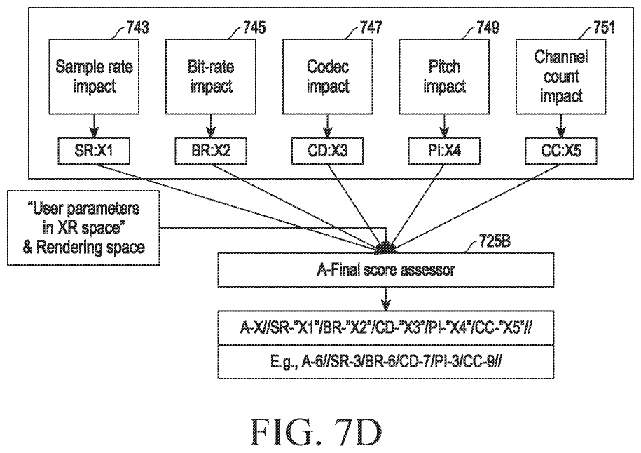

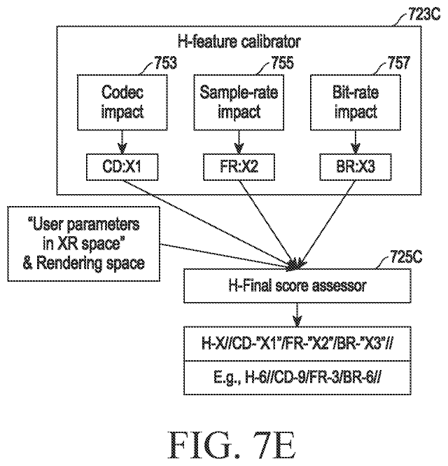

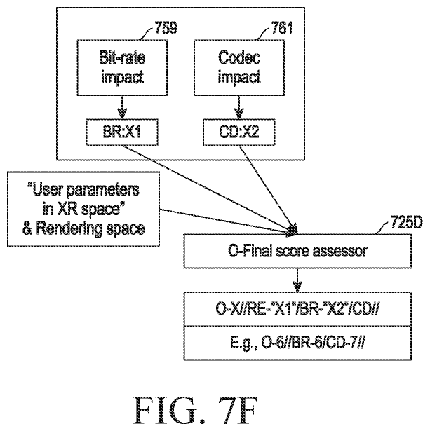

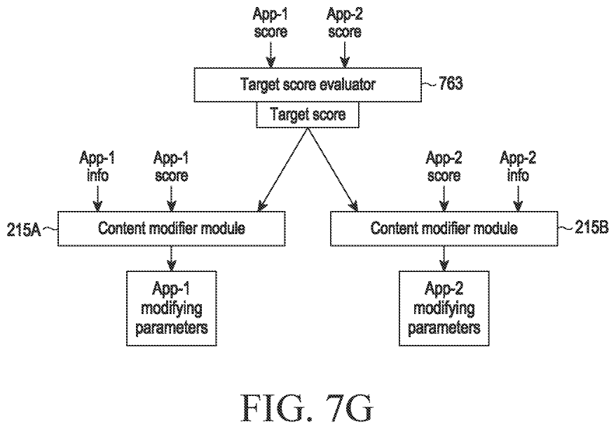

FIG. 7A is a block diagram illustrating a XR-baseline architecture for providing on-device content harmonization of perceptual quality of multiple media streams received from multiple applications according to an embodiment of the disclosure.

Referring to FIG. 7A, multiple application, such as application 1 700A, application 2 700B . . . application n 700N are running on the XR device 201. The multiple applications receive a multiple user input 701 or general user input 701 from the user using the XR device 201. For example, the multiple user input may include but not limited to a user motion, speech, and gesture commands. The XR application 700 serializes multiple user input requests before forwarding for the further processing.

Further, the XR device 201 receives inputs from one or more devices associated with the XR-device 201. The one or more devices associated with the includes, but not limited to sensors 705A, cameras 705B, actuators, 705C, displays 705D, speakers 705E and microphones 705F. Further, the inputs received from one or more devices associated with the XR device 201 can be pre-processed in a XR runtime 707. In addition, the XR runtime 707 provides data parallelly to all multiple applications 700A, 700B, . . . 700N. For example, if multiple applications are registered to get position tracking information, then the XR runtime 707 provides parallelly the position tracking information to all registered applications 700A, 700B . . . 700N. In some embodiments of the disclosure, the XR runtime 707 communicates with the XR source management 709 through an interface IF-1b. The XR source management 709 serializes multiple user inputs 701 before transmitting to the XR runtime 707 for further processing.

Further, in the XR runtime 707, data received from one or more devices associated with the XR device 201 can be pre-processed. For example, sensor data captured by sensor 705A, image data captured by cameras 705B are processed using some of the runtime functions 707A, such as tracking techniques, SLAM techniques, and the like. In some embodiments of the disclosure, the XR runtime functions 707A may receive the user input 701A from the application-1 700A for further processing. Similarly, the data displayed on the displays 705D can be processed or modified using some of the composition techniques 707B and audio content received from speakers 705E and microphones 705F can be processed though audio subsystems 707C using audio processing techniques.

In some embodiments of the disclosure, the XR runtime 707 communicates with XR source management 709 through an interface IF-1b. The XR-source management 709 serializes the request from multiple applications 700A, 700B, . . . 700N before forwarding to the XR runtime 707. Further, the XR source management 709 parallelizes multiple data received from multiple applications 700A, 700B, . . . 700N that needs to be transmitted in the uplink.

Upon the content harmonization, the content harmonizer 209 communicates with a media session handler 715 through an interface IF-6 associated with the application programming interface (API-6). Further, the XR runtime 707 communicates with a content harmonizer 209 through an interface IF-1d. The content harmonizer 209 accesses the media content from XR runtime 707 for multiple applications 700A, 700B, . . . 700N. In addition, the XR runtime 707 communicates with the XR-content harmonizer 209 through an interface IF-1d associated with API-1 and presentation engine 713 through an interface 1F-1c associated with API-1.

The content harmonizer 209 performs an on-device content harmonization for the media streams received from multiple applications 700A, 700B, . . . 700N received through interface IF-11 associated with the application programming interface (API-11), and data received from the XR runtime 707. The content harmonizer 209 comprises three sub-modules namely a score generator module 211, the score evaluator module 213 and a content modifier module 215B. The score generator module 211 extracts at least one media parameter of each of the media stream received from multiple applications 700A, 700B, . . . 700N.

FIG. 7B is a block diagram illustrating a score generator module for determining perceptual quality score of media streams received by multiple applications for on-device harmonization according to an embodiment of the disclosure.

Referring to FIG. 7B, initially a feature extractor 721 of the score generator module 211 initially extracts, at least one media parameter from each of the media stream received from multiple applications. Upon extracting, a feature calibrator of the score generator module 211 generates a calibration table which indicates the impact of each media parameter associated with each of the media stream. Further, the score assessor 725 of the score generator module 211 assesses the user parameters in XR space and rendering space and calibration table and generates a perceptual quality score for each of the media stream received from multiple applications 700A, 700B . . . 700N.

For example, the media streams received from multiple applications 700A, 700B, . . . 700N may include video stream, audio stream, haptic stream, and 3D object stream. Further, a video feature extractor 721A extracts video parameters of the video streams received from multiple applications 700A, 700B, . . . 700N. The video parameters extracted by the video feature extractor 721-1 may include, but not limited to resolution, frame-rate, bit-rate, codec, luminance, and frame-complexity. The frame-complexity can be quantified using measures like Shannon Entropy. For example, a video frame with plain background and very few objects will be less complex, whereas a frame with lots of texture and objects will be more complex.

Similarly, an audio feature extractor 721B extracts audio parameters of the audio streams received from multiple applications 700A, 700B, . . . 700N. The audio parameters may include, but not limited to sample rate, pitch, codec, bitrate and channel count. Furthermore, haptics feature extractor 721C extracts haptic parameters of the haptics streams received from multiple applications 700A, 700B, . . . 700N. The haptics parameters may include, but not limited to sample rate, codec and bitrate. In addition, a 3D object feature extractor extracts the 3D object parameters of the 3D object streams received from multiple applications 700A, 700B, . . . 700N. The 3D object parameters may include, but not limited to codec and bitrate.

Upon, the feature extraction, feature calibrator 723 of the score generator module 211 generates a calibration table based on the media parameters extracted from the feature extractor 721. The V-feature calibrator 723A generates the calibration table for each of the video parameters of the video stream received from the video feature extractor 721A. The A-feature calibrator 723B generates the calibration table for each of the audio parameters of the audio streams received from the audio feature extractor 721B. Further, the H-feature calibrator 723C generates the calibration table for each of the haptics parameters received from the haptics feature extractor 721C. An O-feature calibrator 723D generates a calibration table for each of the 3D object parameters received from the 3D object feature extractor 721D. Upon the generation of calibration table, the score assessor 725 of the score generator module 211 determines a perceptual quality score for each of the media stream received from multiple applications 700A, 700B, . . . 700N based on the calibration table and the user parameters in XR space and rendering space. A V-score assessor 725A determines the perceptual quality score 727A for each of the video stream received from multiple applications based on the calibration table generated by the V-feature calibrator 723A and the user parameters in XR space and rendering space. Similarly, A-score assessor 725B determines the perceptual quality score 727B for each of the audio stream received from multiple applications based on the calibration table generated by the A-feature calibrator 723B and the user parameters in XR space and rendering space. Moreover, H-score assessor 725C determines the perceptual quality score 727C for each of the haptics stream received from multiple applications based on the calibration table generated by the H-feature calibrator 723C and the user parameters in XR space and rendering space. In addition, O-score assessor 725D generates a perceptual quality score 727D for each of the 3D object stream received from multiple applications based on the calibration table generated by the O-feature calibrator 723D and the user parameters in XR space and rendering space.

FIGS. 7C, 7D, 7E, and 7F are block diagrams illustrating a perceptual quality score generation of media streams for multiple applications by a feature calibrator and feature assessor associated with a score generator module according to various embodiments of the disclosure.

For example, referring to FIG. 7C, the V-feature calibrator 723A determines the impact of each video parameter on the video stream using an AI model. The AI model may analyse the impact of the video parameter on the video stream by varying the value of the video parameters and determining the impact on the video stream based on varied value of the video parameter. Further, based on the analysis the V-feature calibrator 723A assigns a value to each video parameter indicating the impact on the video stream. The V-feature calibrator 723A may determine the resolution impact 731 on the video stream as X1, which is represented as RE:X1. Similarly, the V-feature calibrator 723A may determine the frame-rate impact 733, bitrate impact 735, codec impact 737, luminance impact 739, frame-complexity impact 741 on the video stream as X2, X3, X4, X5 and X6 respectively. The calibration table generated by the V-feature calibrator 723-1 can be represented as/RE-“X1”/FR-“X2”/BR-“X3”/CD-“X4”/LU-“X5”/FC-“X6”/, where the value of “X” may range between 0-9. 0 indicates the lowest impact of the video parameter on the video stream and 9 indicates the highest impact of the video parameter on the video stream. Upon the generation of calibration table, the V-score assessor 725-A determines the perceptual quality score of each of the video stream received from multiple applications 700A, 700B, . . . ,700N based on the calibration table and user parameters in XR space and rendering space.

For example, referring to FIG. 7D, the A-feature calibrator 723A determines the impact of each audio parameter on the audio stream using an AI model. The AI model may analyse the impact of the audio parameter on the audio stream by varying the value of the audio parameters and determining the impact on the audio stream based on varied value of the audio parameter. Further, based on the analysis the A-feature calibrator 723B assigns a value to each audio parameter indicating the impact on the audio stream. The A-feature calibrator 723B may determine the sample impact 743 on the audio stream as X1, which is represented as SR:X1. Similarly, the A-feature calibrator 723B may determine the bitrate impact 745, codec impact 747, pitch impact 749, channel count impact 751 on the audio stream as X2, X3, X4, and X5 respectively. The calibration table generated by the A-feature calibrator 723B can be represented as /SR-“X1”/BR-“X2”/CD-“X3”/PI-“X4”/CC-“X5”/, where the value of “X” may range between 0-9. 0 indicates the lowest impact of the audio parameter on the audio stream and 9 indicates the highest impact of the audio parameter on the audio stream. Upon the generation of calibration table, the A-score assessor 725B determines the perceptual quality score of each of the audio stream received from multiple applications 700A, 700B, . . . ,700N based on the calibration table and user parameters in XR space and rendering space.

For example, referring to FIG. 7E, the H-feature calibrator 723C determines the impact of haptics parameter on the haptics stream using an AI model. The AI model may analyse the impact of the haptics parameter on the haptics stream by varying the value of the haptics parameters and determining the impact on the haptics stream based on varied value of the haptics parameter. Further, based on the analysis the H-feature calibrator 723C assigns a value to each haptic parameter indicating the impact on the haptics stream. The H-feature calibrator 723C may determine the codec impact 753 on the haptic stream as X1, which is represented as CD:X1. Similarly, the H-feature calibrator 723C may determine the sample-rate impact 755, and bitrate impact 757 on the haptics stream as X2 and X3 respectively. The calibration table generated by the H-feature calibrator 723C can be represented as CD-“X1”/FR-“X2”/BR-“X3”/, where the value of “X” may range between 0-9. 0 indicates the lowest impact of the haptics parameter on the haptics stream and 9 indicates the highest impact of the haptics parameter on the haptics stream. Upon the generation of calibration table, the H-score assessor 725C determines the perceptual quality score of each of the haptics stream received from multiple applications 700A, 700B, . . . ,700N based on the calibration table and user parameters in XR space and rendering space.

For example, referring to FIG. 7F, the O-feature calibrator 723D determines the impact of 3D object parameter on the 3D object stream using an AI model. The AI model may analyse the impact of the 3D object parameter on the 3D object stream by varying the value of the 3D object parameters and determining the impact on the 3D object stream based on varied value of the 3D object parameter. Further, based on the analysis the O-feature calibrator 723D assigns a value to each 3D object parameter indicating the impact on the 3D object stream. The O-feature calibrator 723D may determine the bit rate impact 759 on the 3D object stream as X1, which is represented as CD:X1. Similarly, the O-feature calibrator 723D may determine the codec impact 761, on the 3D object stream as X2. The calibration table generated by the O-feature calibrator 723D can be represented as RE-“X1”/BR-“X2”/CD”, where the value of “X” may range between 0-9. 0 indicates the lowest impact of the 3D object parameter on the 3D object stream and 9 indicates the highest impact of the 3D object parameter on the 3D object stream. Upon the generation of calibration table, the O-score assessor 725-4 determines the perceptual quality score of each of the 3D object stream received from multiple applications 700A, 700B, . . . ,700N based on the calibration table and user parameters in XR space and rendering space.

Upon the generation of the perceptual quality score for each of the media stream received from multiple applications 700A, 700B, . . . 700N, the content harmonizer 209 determines candidate applications with different media quality from the plurality of application 700A, 700B, . . . 700N based on the perceptual quality score for the at least one media stream received from each application of the plurality of applications 700A, 700B, . . . 700N. Further, the content harmonizer 209 determines a target perceptual quality score for at least one media stream based on the determined perceptual quality score of media streams for candidate applications. Finally, the content modifier module 215A of the content harmonizer 209 modifies the media parameter values based on the determined target perceptual score for at least one media stream of the candidate applications and the application information. For example, the application information may include but not limited to a Codecs, and resolutions.

FIG. 7G is a schematic block diagram illustrating a target score evaluator for generating target perceptual quality score and harmonizing a media stream received from multiple applications according to an embodiment of the disclosure.

Referring to FIG. 7G, a target score evaluator 763 determines the target perceptual quality score based on the perceptual quality score determined by the media score assessor 725 for candidate applications. The target score evaluator 763, receives the perceptual quality scores generated for the media stream received from at least one candidate application. Further, the target score evaluator 763 generates the target perceptual quality score for the media stream received from at least one candidate application based on the received perceptual quality scores generated for the media stream received from the candidate application. Upon the generation of the target perceptual quality score, the content modifier module 215B upscales or downscales the media parameter values based on the determined target perceptual score for at least one media stream of the candidate applications and the application information. For example, the application information includes codecs, resolution and the like.

For example, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.7. The bandwidth ratio is ratio between the available bandwidth and the bandwidth used. For the bandwidth ratio being 1.7, consider the corresponding weight factor is 3 for application 1 and 7 for application 2.

$$The target perceptual quality score = ( 3 * 4 + 7 * 8 ) / ( 3 + 7 ) = 6.8 = ∼ 7 .$$

Upon the generation of the target perceptual quality score, the content modifier module 215B up-samples the video resolution of the application 1 by factor of 2 in order to increase the perceptual quality score of the video stream from 4 to 7. However, content modifier module 215B does make any further modification in the media parameters of the media streams received from application 2. In addition, the content modifier module 215B indicates the harmonized renderer 313 regarding the up-sampling of the video parameters of the application 1.

In some embodiments of the disclosure, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.1. The bandwidth ratio is ratio between the available bandwidth and the bandwidth used. For the bandwidth ratio being 1.7, consider the corresponding weight factor is 7 for application 1 and 3 for application 2.

$$Target perceptual quality Score = ( 7 * 3 + 3 * 8 ) / ( 3 + 7 ) = 4.5 = ∼ 5$$

Upon the generation of the target perceptual quality score, the content modifier module 215B down-samples the video resolution of the application 2 by factor of 2 in order to decrease the perceptual quality score of the video stream from 8 to 5. However, content modifier module 215B does make any further modification in the media parameters of the media streams received from application 1. In addition, the content modifier module 215B indicates the harmonized renderer 313 regarding the down-sampling of the video parameters of the application 2.

Upon the content harmonization, the content harmonizer 209 communicates with a scene manager 717 through an interface IF-12 associated with API-12. The scene manager 717 renders multiple media streams which in the user's observation range. In addition, the scene manager 717 performs the occlusion control. The scene manager 717 helps multiple applications in arranging the logical and spatial representation of a multisensory scene based on support from the XR runtime 707 and XR content manager/content harmonizer 209. In addition, the content harmonizer 209 communicates with a media access function 719 through an interface IF-7 associated with API-7. The IF-7 helps XR content manager/content harmonizer 209 to get media content of multiple applications from media access function 719. Finally, the media access function 719 enables access to media streams to be communicated through the 5G system over an interface IF-4.

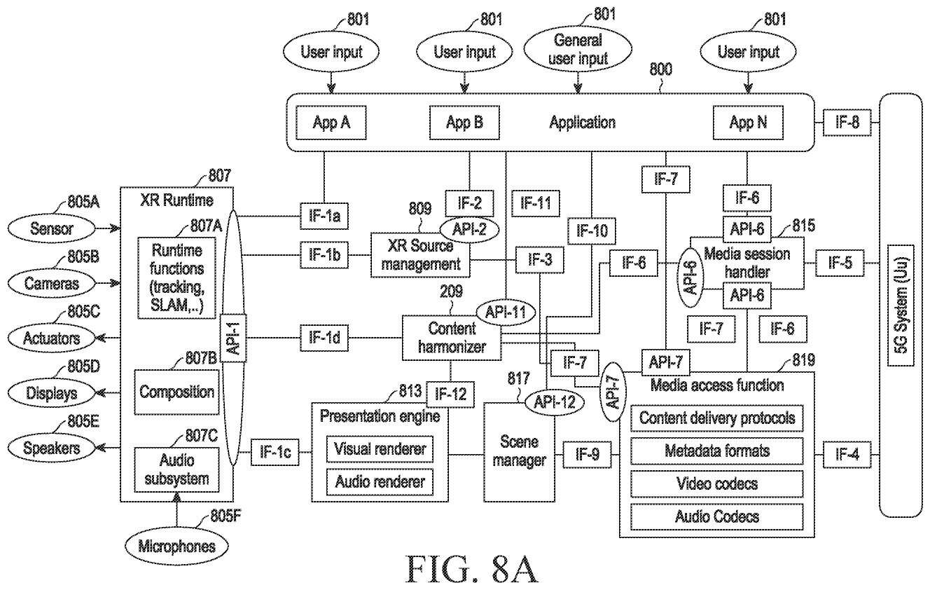

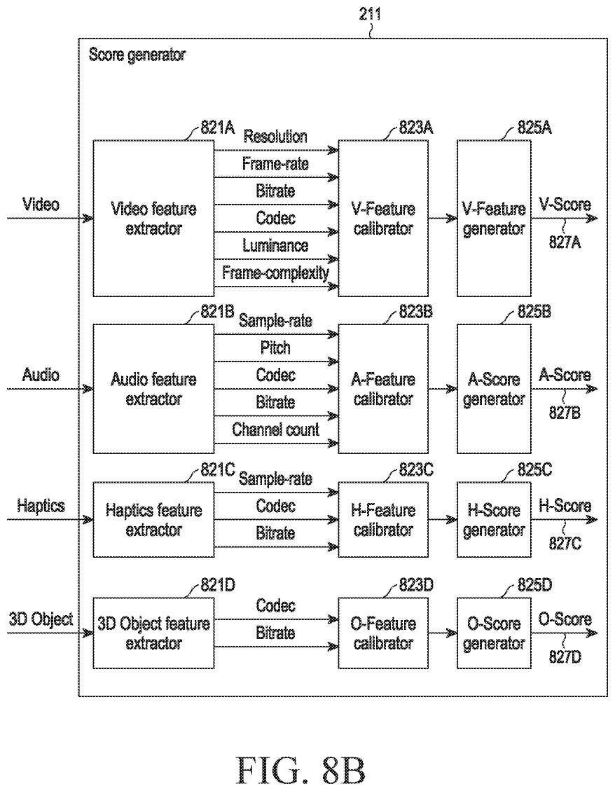

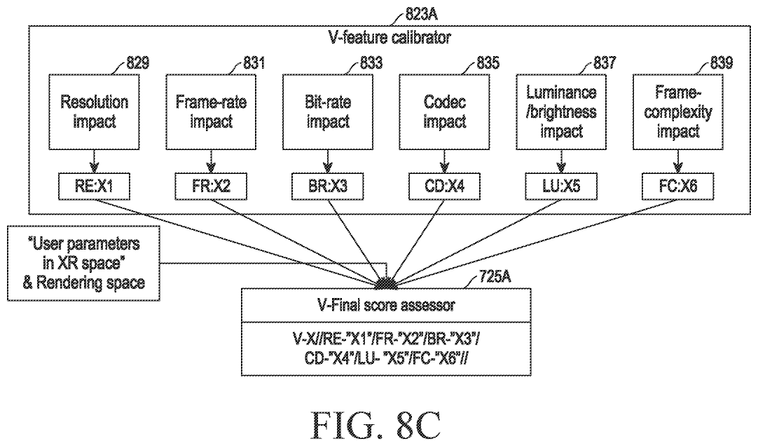

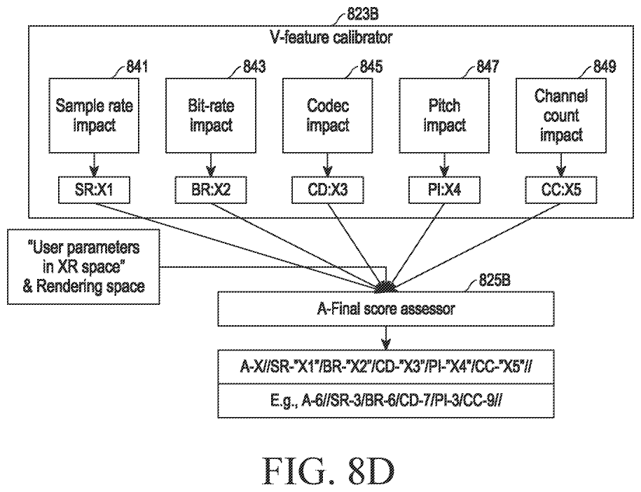

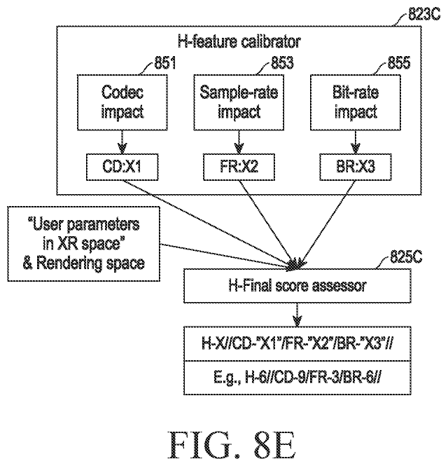

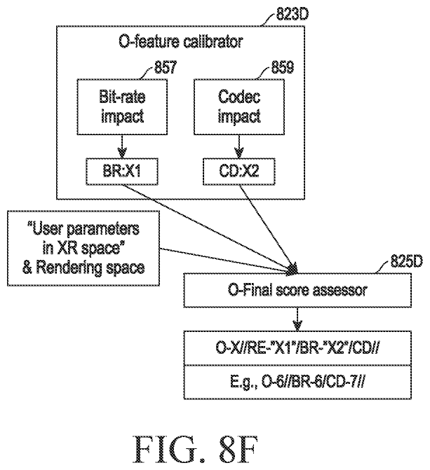

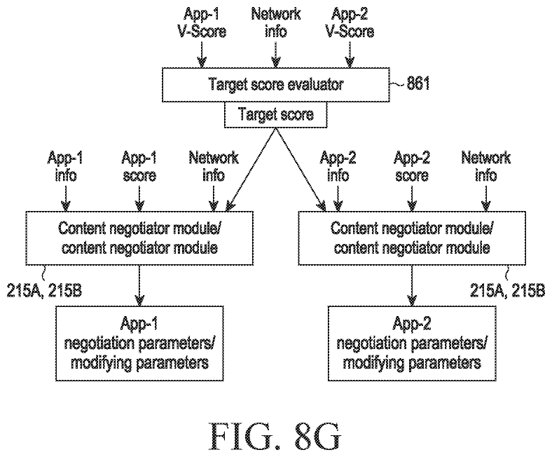

FIG. 8A is a block diagram illustrating a XR-baseline architecture for providing a combination of service level and on-device content harmonization of perceptual quality of multiple media streams received from multiple applications according to an embodiment of the disclosure.

Referring to FIG. 8A, multiple application, such as application 1 800A, application 2 800B . . . application n 800N are running on the XR device 201. The multiple applications receive a user input 801 or general user input 801 from the user using the XR device 201. For example, the multiple user input may include but not limited to a user motion, speech, and gesture commands. An XR application 800 serializes multiple user input requests before forwarding for the further processing.

Further, the XR device 201 receives inputs from one or more devices associated with the XR-device 201. The one or more devices associated with the includes, but not limited to sensors 805A, cameras, 805B, actuators, 805C, displays 805D, speakers 805E and microphones 805F. Further, the inputs received from one or more devices associated with the XR device 201 can be pre-processed in a XR runtime 807. In addition, the XR runtime 807 provides data parallelly to all multiple applications 800A, 800B, . . . 800N. For example, if multiple applications are registered to get position tracking information, then the XR runtime 807 provides parallelly the position tracking information to all registered applications 800A, 800B . . . 800-N−1. In some embodiments of the disclosure, the XR runtime 807 communicates with the XR source management 809 through an interface IF-1b. The XR source management 809 serializes multiple user inputs 801 before transmitting to the XR runtime 807 for further processing. In addition, the XR runtime 807 communicates with the XR-content harmonizer 209 through an interface IF-1d associated with API-1 and presentation engine 813 through an interface 1F-1c associated with API-1.

Further, in the XR runtime 807, data received from one or more devices associated with the XR device 201 can be pre-processed. For example, sensor data captured by sensor 805A, image data captured by cameras 805B are processed using some of the runtime functions 807A, such as tracking techniques, SLAM techniques and the like. In some embodiments of the disclosure, the XR runtime functions 807A may receive the user input 801A from the application-1 800A for further processing. Similarly, the data displayed on the displays 805D can be processed or modified using some of the composition techniques 807B and audio content received from speakers 805E and microphones 805-F can be processed though audio subsystems 807C using audio processing techniques.

In some embodiments of the disclosure, the XR runtime 807 communicates with XR source management 809 through an interface IF-1b. The XR-source management 809 serializes the request from multiple applications 800-1, 800-2, . . . 800-n before forwarding to the XR runtime 807. Further, the XR source management 809 parallelizes multiple data received from multiple applications 800A, 800B, . . . 800N that needs to be transmitted in the uplink.

Further, the XR runtime 807 communicates with a XR content harmonizer 811 through an interface IF-1d. The XR content harmonizer 811 accesses the media content from XR runtime 807 for multiple applications 800A, 800B, . . . 800N.

The content harmonizer 811 performs a combination of both on-device and service level content harmonization for the media streams received from multiple applications 800A, 800B, . . . 800N received through interface IF-11 associated with the application programming interface (API-11), and data received from the XR runtime 807. The content harmonizer 811 comprises four sub-modules namely a score generator module 211, the score evaluator module 213, a content negotiator module 215A and a content modifier module 215B. The score generator module 211 extracts at least one media parameter of each of the media stream received from multiple applications 800A, 800B, . . . 800N.

FIG. 8B is a block diagram illustrating a score generator module for determining perceptual quality score of media streams received by multiple applications for a combination of on-device and service level harmonization according to an embodiment of the disclosure.

Referring to FIG. 8B, initially a feature extractor 821 of the score generator module 211 initially extracts, at least one media parameter from each of the media stream received from multiple applications. Upon extracting, a feature calibrator 823 of the score generator module 211 generates a calibration table which indicates the impact of each media parameter associated with each of the media stream. Further, the score assessor 725 of the score generator module 211 assesses the user parameters in XR space and rendering space and calibration table and generates a perceptual quality score for each of the media stream received from multiple applications 800A, 800B . . . 800N.

For example, the media streams received from multiple applications 800A, 800B, . . . 800N may include video stream, audio stream, haptic stream, and 3D object stream. Further, a video feature extractor 821A extracts video parameters of the video streams received from multiple applications 800A, 800B, . . . 800N. The video parameters extracted by the video feature extractor 821A may include, but not limited to resolution, frame-rate, bit-rate, codec, luminance, and frame-complexity. The frame-complexity can be quantified using measures like Shannon Entropy. For example, a video frame with plain background and very few objects will be less complex, whereas a frame with lots of texture and objects will be more complex. Similarly, an audio feature extractor 821B extracts audio parameters of the audio streams received from multiple applications 800A, 800B, . . . 800N. The audio parameters may include, but not limited to sample rate, pitch, codec, bitrate and channel count. Furthermore, haptics feature extractor 821C extracts haptic parameters of the haptics streams received from multiple applications 800A, 800B, . . . 800N. The haptics parameters may include, but not limited to sample rate, codec and bitrate. In addition, a 3D object feature extractor 821D extracts the 3D object parameters of the 3D object streams received from multiple applications 800A, 800B, . . . 800N. The 3D object parameters may include, but not limited to codec and bitrate.

Upon, the feature extraction, feature calibrator 823 of the score generator module 211 generates a calibration table based on the media parameters extracted from the feature extractor 821. The V-feature calibrator 723A generates the calibration table for each of the video parameters of the video stream received from the video feature extractor 721A. The A-feature calibrator 823A generates the calibration table for each of the audio parameters of the audio streams received from the audio feature extractor 821B. Further, the H-feature calibrator 823C generates the calibration table for each of the haptics parameters received from the haptics feature extractor 821C. An O-feature calibrator 823D generates a calibration table for each of the 3D object parameters received from the 3D object feature extractor 821D. Upon the generation of calibration table, the score assessor 825 of the score generator module 211 determines a perceptual quality score for each of the media stream received from multiple applications 800A, 800B, . . . 800N based on the calibration table and the user parameters in XR space and rendering space. A V-score generator 825A determines the perceptual quality score 827A for each of the video stream received from multiple applications based on the calibration table generated by the V-feature calibrator 823A and the user parameters in XR space and rendering space. Similarly, A-score generator 825B determines the perceptual quality score 827B for each of the audio stream received from multiple applications based on the calibration table generated by the A-feature calibrator 823B and the user parameters in XR space and rendering space. Moreover, H-score generator 825C determines the perceptual quality score 827C for each of the haptics stream received from multiple applications based on the calibration table generated by the H-feature calibrator 823C and the user parameters in XR space and rendering space. In addition, O-score generator 825D generates a perceptual quality score 827D for each of the 3D object stream received from multiple applications based on the calibration table generated by the O-feature calibrator 823D and the user parameters in XR space and rendering space.

FIGS. 8C, 8D, 8E, and 8F are block diagrams illustrating a perceptual quality score generation of media streams for multiple applications by a feature calibrator and feature assessor associated with a score generator module according to various embodiments of the disclosure.

For example, referring to FIG. 8C, the V-feature calibrator 823A determines the impact of each video parameter on the video stream using an AI model. The AI model may analyse the impact of the video parameter on the video stream by varying the value of the video parameters and determining the impact on the video stream based on varied value of the video parameter. Further, based on the analysis the V-feature calibrator 823A assigns a value to each video parameter indicating the impact on the video stream. The V-feature calibrator 823A may determine the resolution impact 829 on the video stream as X1, which is represented as RE:X1. Similarly, the V-feature calibrator 823A may determine the frame-rate impact 831, bitrate impact 833, codec impact 835, luminance impact 837, frame-complexity impact 839 on the video stream as X2, X3, X4, X5 and X6 respectively. The calibration table generated by the V-feature calibrator 823A can be represented as/RE-“X1”/FR-“X2”/BR-“X3”/CD-“X4”/LU-“X5”/FC-“X6”/, where the value of “X” may range between 0-9. 0 indicates the lowest impact of the video parameter on the video stream and 9 indicates the highest impact of the video parameter on the video stream. Upon the generation of calibration table, the V-score generator 825A determines the perceptual quality score of each of the video stream received from multiple applications 800A, 800B, . . . ,800N based on the calibration table and user parameters in XR space and rendering space.

For example, referring to FIG. 8D, the A-feature calibrator 823A determines the impact of each audio parameter on the audio stream using an AI model. The AI model may analyse the impact of the audio parameter on the audio stream by varying the value of the audio parameters and determining the impact on the audio stream based on varied value of the audio parameter. Further, based on the analysis the A-feature calibrator 823B assigns a value to each audio parameter indicating the impact on the audio stream. The A-feature calibrator 823C may determine the sample impact 841 on the audio stream as X1, which is represented as SR:X1. Similarly, the A-feature calibrator 823B may determine the bitrate impact 843, codec impact 845, pitch impact 847, channel count impact 849 on the audio stream as X2, X3, X4, and X5 respectively. The calibration table generated by the A-feature calibrator 823B can be represented as /SR-“X1”/BR-“X2”/CD-“X3”/PI-“X4”/CC-“X5”/, where the value of “X” may range between 0-9. 0 indicates the lowest impact of the audio parameter on the audio stream and 9 indicates the highest impact of the audio parameter on the audio stream. Upon the generation of calibration table, the A-score generator 825B determines the perceptual quality score of each of the audio stream received from multiple applications 800A, 800B, . . . ,800N based on the calibration table and user parameters in XR space and rendering space.

For example, referring to FIG. 8E, the H-feature calibrator 823C determines the impact of haptics parameter on the haptics stream using an AI model. The AI model may analyse the impact of the haptics parameter on the haptics stream by varying the value of the haptics parameters and determining the impact on the haptics stream based on varied value of the haptics parameter. Further, based on the analysis the H-feature calibrator 823C assigns a value to each haptic parameter indicating the impact on the haptics stream. The H-feature calibrator 823C may determine a codec impact 851 on the haptic stream as X1, which is represented as CD:X1. Similarly, the H-feature calibrator 823C may determine the sample-rate impact 853, and bitrate impact 855 on the haptics stream as X2 and X3 respectively. The calibration table generated by the H-feature calibrator 823C can be represented as CD-“X1”/FR-“X2”/BR-“X3”/, where the value of “X” may range between 0-9. 0 indicates the lowest impact of the haptics parameter on the haptics stream and 9 indicates the highest impact of the haptics parameter on the haptics stream. Upon the generation of calibration table, the H-score assessor 825C determines the perceptual quality score of each of the haptics stream received from multiple applications 800A, 800B, . . . , 800N based on the calibration table and user parameters in XR space and rendering space.

For example, referring to FIG. 8F, the O-feature calibrator 823D determines the impact of 3D object parameter on the 3D object stream using an AI model. The AI model may analyse the impact of the 3D object parameter on the 3D object stream by varying the value of the 3D object parameters and determining the impact on the 3D object stream based on varied value of the 3D object parameter. Further, based on the analysis the O-feature calibrator 823D assigns a value to each 3D object parameter indicating the impact on the 3D object stream. The O-feature calibrator 823D may determine a bit rate impact 857 on the 3D object stream as X1, which is represented as CD:X1. Similarly, the O-feature calibrator 823D may determine a codec impact 859, on the 3D object stream as X2. The calibration table generated by the O-feature calibrator 823D can be represented as RE-“X1”/BR-“X2”/CD”, where the value of “X” may range between 0-9. 0 indicates the lowest impact of the 3D object parameter on the 3D object stream and 9 indicates the highest impact of the 3D object parameter on the 3D object stream. Upon the generation of calibration table, the O-score generator 725D determines the perceptual quality score of each of the 3D object stream received from multiple applications 800A, 800B, . . . , 800N based on the calibration table and user parameters in XR space and rendering space.

Upon the generation of the perceptual quality score for each of the media stream received from plurality of applications 800A, 800B, . . . 800N, the content harmonizer 811 determines candidate applications with different media quality from the plurality of application 800A, 800B, . . . 800N based on the perceptual quality score for the at least one media stream received from each application of the plurality of applications 800A, 800B, . . . 800N. Further, the content harmonizer 811 determines a target perceptual quality score for at least one media stream based on the determined perceptual quality score of media streams for candidate applications and network parameters. The network parameters may include, but not limited to network bandwidth, network congestion, a network quality of service (QoS) identifier, the XR device capability and capability of XR device, capability of at least one server from which the at least one stream is received, and latency requirements. Finally, the content negotiator module 215-A and content modifier module 215-B of the content harmonizer 811 performs at least one of renegotiates with a server for modifying the media parameters of the media streams based on the target perceptual quality score and also upscales or downscales the media parameter values based on the determined target perceptual score for at least one media stream of the candidate applications, network parameters and the application information. The renegotiation or upscaling/downscaling of the media parameters is performed by determining the difference between the perceptual quality score, and the target perceptual quality score and the calibration table. If the difference is high, then the multiple media parameters having a high value in the calibration table is modified. Similarly, if the difference is low, then the multiple parameters having a low value in the calibration table is modified.

FIG. 8G is a schematic block diagram illustrating both an on-device content harmonization and service level harmonization of perceptual quality of media streams of multiple applications by a score harmonizer according to an embodiment of the disclosure.

Referring to FIG. 8G, a target score evaluator 861 determines the target perceptual quality score based on the perceptual quality score determined by the media score generator 825 for candidate applications, and network parameters. The target score evaluator 861, receives the perceptual quality scores generated for the media stream received from at least one candidate application and network parameters. Further, the target score evaluator 861 generates the target perceptual quality score for the media stream received from at least one candidate application based on the received perceptual quality scores generated for the media stream received from the candidate application and network parameters. Upon the generation of the target perceptual quality score, at least one of the content negotiator module 215A and content modifier module 215B performs renegotiation with a server for modifying the media parameters of the media streams based on the target perceptual quality score and network parameters; and upscales or downscales the media parameter values based on the determined target perceptual score for at least one media stream of the candidate applications and the application information respectively. For example, the application information includes codecs, resolution and the like.

For example, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.7. The bandwidth ratio is ratio between the available bandwidth and the bandwidth used. For the bandwidth ratio being 1.7, consider the corresponding weight factor is 3 for application 1 and 7 for application 2.

$$The target perceptual quality score = ( 3 * 4 + 7 * 8 ) / ( 3 + 7 ) = 6.8 = ∼ 7 .$$

Upon the generation of the target perceptual quality score, the content modifier module 215B up-samples the video resolution of the application 1 by factor of 2 and the content negotiator module 215A re-negotiates for an increase in bitrate with the server associated with application 2. The modification and re-negotiation is performed in order to increase the perceptual quality score of the video stream from 4 to 7.

In some embodiments of the disclosure, consider the perceptual quality score determined for the application 1 is V-4//RE-9/BR-6/CD-4/, and the perceptual quality score of the application 2 is V-8//RE-9/BR-4/CD-6/. Further, consider the bandwidth ratio is having a value 1.1. The bandwidth ratio is ratio between the available bandwidth and the bandwidth used. For the bandwidth ratio being 1.7, consider the corresponding weight factor is 7 for application 1 and 3 for application 2.

$$Target perceptual quality Score = ( 7 * 3 + 3 * 8 ) / ( 3 + 7 ) = 4.5 = ∼ 5$$

Upon the generation of the target perceptual quality score, the content modifier module 215B down-samples the video resolution of the application 2 by factor of 2 and the content negotiator module 215A re-negotiates with server associated with the application 2 to lower the bitrate value of the application 2 in order to decrease the perceptual quality score of the video stream from 8 to 5.

Upon the content harmonization, the content harmonizer 209 communicates with a scene manager 817 through an interface IF-12 associated with API-12. The scene manager 817 helps multiple applications in arranging the logical and spatial representation of a multisensory scene based on support from the XR Runtime 807 and content harmonizer 209. In addition, the content harmonizer 209 communicates with a media access function 819 through an interface IF-7 associated with API-7. The IF-7 helps XR Content manager/content harmonizer 209 to get media content of multiple applications from media access function 819. In addition, the content harmonizer 209 communicates with a media session handler 815 through an interface IF-6 associated with API-6. The media session handler 815 offers tools for content harmonizer 209 to negotiate media parameters with the server associated with the plurality of applications. In some embodiments of the disclosure, the media session handler 815 activates 5G media functionality, such as network assistance, edge resource discovery, edge computation offload, and the like. In addition, the media access function 819 enables access to media streams to be communicated through the 5G system over an interface IF-4.

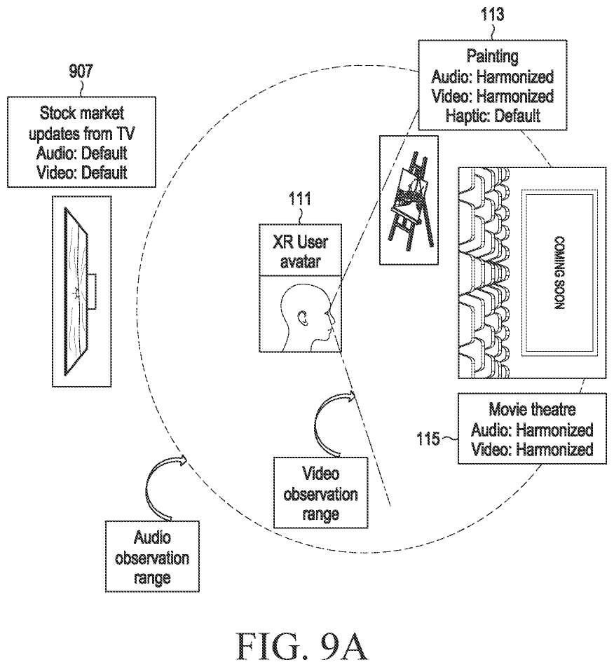

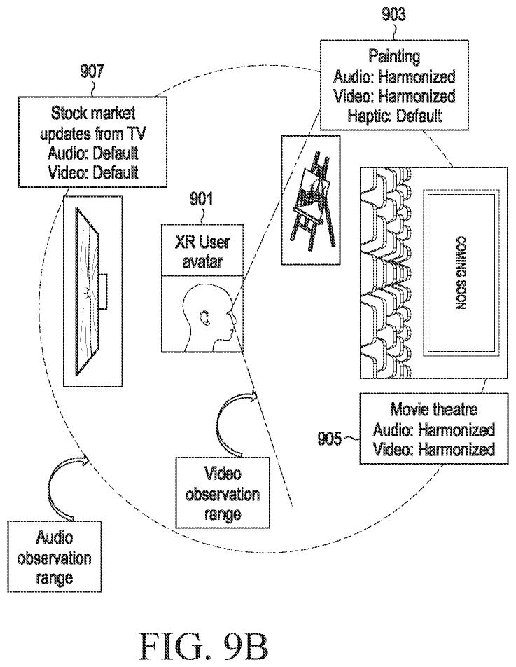

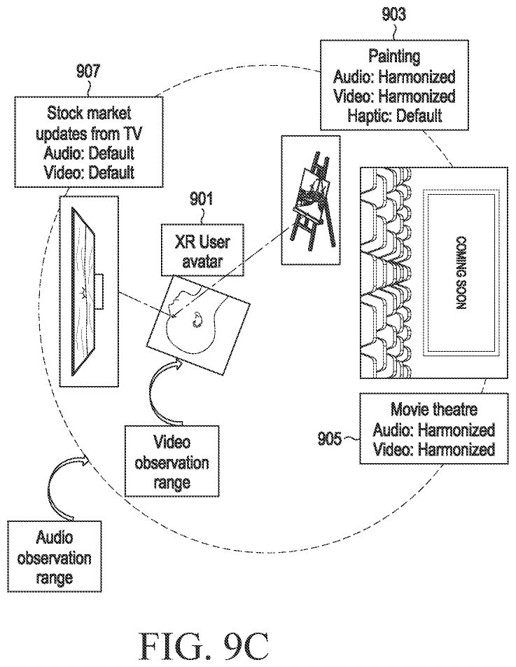

FIGS. 9A, 9B, and 9C illustrate scenarios of harmonizing perceptual quality of media streams received from plurality of applications in an XR environment according to various embodiments of the disclosure.

Referring to FIG. 9A, a user 901 is using multiple applications in a XR environment 900. The multiple applications include a painting application 903, a movie application 905 and a TV application 907. The painting application 903 has audio stream, video stream and haptics stream. Similarly, the movie application has audio streams and video streams. Further, the TV applications also has audio stream and video stream. In the FIG. 9A the user 901 is looking towards the painting application 903 and movie application 905 which are closely located to the XR environment 900. However, the TV application 907 is not in the user view or audible range. Further, the content harmonizer 209, determines a perceptual quality score for audio streams and video streams received from painting application 903 and movie application 905. Thereafter, the content harmonizer 209, determines a target perceptual quality score based on the determined perceptual quality score and the network parameters. Finally, the content harmonizer 209, harmonizes the perceptual quality of at least one of the audio stream and video stream received from the at least one of the painting applications 903 and movie applications 905. However, the haptic stream of the painting application is not harmonized since there no haptics stream in the movie application.

Referring to FIG. 9B, consider a scenario, where the user 901 is using multiple applications in a XR environment 900. The multiple applications include a painting application 903, a movie application 905 and a TV application 907. The painting application 903 has audio stream, video stream and haptics stream. Similarly, the movie application has audio streams and video streams. Further, the TV applications also has audio stream and video stream. In the FIG. 9B the user 901 is looking towards the painting application 903 and movie application 905 which are closely located to the XR environment 900. Further, the TV application 907 is also within the in the audible range of the user view. The content harmonizer 209, determines a perceptual quality score for audio streams and video streams received from painting application 9, movie application 905 and audio stream of the TV application 907. Thereafter, the content harmonizer 209, determines a target perceptual quality score based on the determined perceptual quality score and the network parameters. Finally, the content harmonizer 209, harmonizes the perceptual quality of the video stream received from the at least one of the painting applications 903 and movie applications 905. In addition, the content harmonizer 209, harmonizes the perceptual quality of the audio stream received from at least one of the painting application, movie application and TV application. However, the haptic stream of the painting application is not harmonized since there no haptics stream in either of the movie application and TV application.

Referring to FIG. 9C, consider a scenario, where the user 901 is using multiple applications in a XR environment 900. The multiple applications include a painting application 903, a movie application 905 and a TV application 907. The painting application 903 has audio stream, video stream and haptics stream. Similarly, the movie application has audio streams and video streams. Further, the TV applications also has audio stream and video stream. In the FIG. 9C the user 901 is looking towards the painting application 903 and the TV application 907. Further, the movie application 905 is not present within the video observation range of the user 901. Further, the movie application 905 is within the in the audible range of the user view. The content harmonizer 209, determines a perceptual quality score for video streams, audio streams, haptics stream received from at least one of the painting application 903, TV application 907 and movie application 905. Thereafter, the content harmonizer 209, determines a target perceptual quality score based on the determined perceptual quality score and the network parameters. Finally, the content harmonizer 209, harmonizes the perceptual quality of the video stream received from the at least one of the painting applications 903 and TV applications 907. In addition, the content harmonizer 209, harmonizes the perceptual quality of the audio stream received from at least one of the painting application 903, movie application 905 and TV application 907. However, the haptic stream of the painting application is not harmonized since there no haptics stream in either of the movie application 905 and TV application 907.

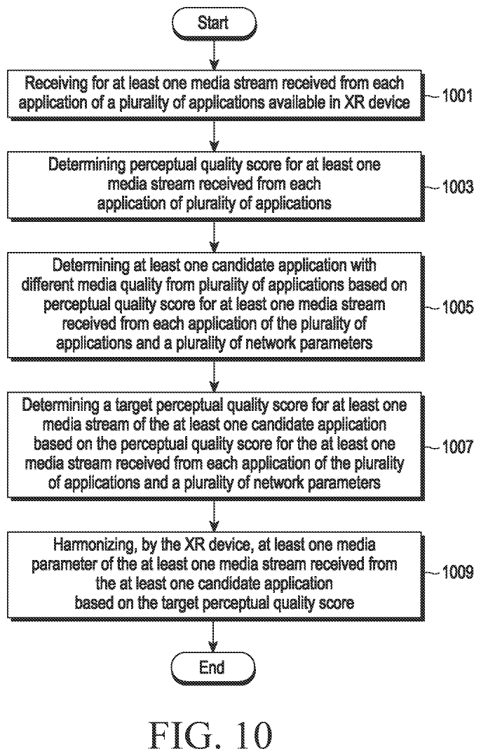

FIG. 10 is a flow diagram illustrating a method of harmonizing perceptual quality of multiple applications in an extended reality (XR) environment according to an embodiment of the disclosure.

Referring to FIG. 10, at operation 1001, the content harmonizer 209 of XR device 201, receives at least one media stream received from each application of a plurality of applications available in the XR device 201.

At operation 1003, the content harmonizer 209 of the XR device 201, determines perceptual quality score for at least one media stream received each application of plurality of applications. The perceptual quality score for at least one media stream is determined based on the calibration table and the network parameters. The calibration table indicates the impact of each media parameter of at least one media stream received from plurality of applications. The network parameters include, but not limited to a network bandwidth, network congestion, a network quality of service (QoS) identifier, capability of XR device, capability of at least one server from which the at least one stream is received, and latency requirements.

At operation 1005, the content harmonizer 209 of the XR device 201, determines at least one candidate application with different quality from plurality of applications based on perceptual quality score for at least one media stream received from each application of plurality of applications. The candidate applications are the applications for which the perceptual quality scores are different and require the harmonization of the perceptual quality of media streams received from plurality of applications.

At operation 1007, the content harmonizer 209 of the XR device 201, determines a target perceptual quality score for at least one media stream of the at least one candidate application based on the determined perceptual quality score for the candidate applications and plurality of network parameters.

At operation 1009, the content harmonizer 209 of the XR device 201, harmonizes at least one media parameter of the at least one media stream received from the at least one candidate application based on the target perceptual quality score. The content harmonizer 209 harmonizes the media parameter of the at least one media stream by at least one of modifying the media parameter value based on target perceptual quality score and re-negotiating with the server associated with the candidate application to stream the candidate application with a target perceptual quality score.

It will be appreciated that various embodiments of the disclosure according to the claims and description in the specification can be realized in the form of hardware, software or a combination of hardware and software.

Any such software may be stored in a non-transitory computer readable storage medium. The non-transitory computer readable storage medium stores one or more computer programs (software modules), the one or more computer programs comprising instructions, which when executed by one or more processors in an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of harmonizing perceptual quality of multiple applications in an extended reality (XR) environment, the method comprising:
receiving, by an XR device, at least one media stream received from each application of a plurality of applications available in the XR device;
determining, by the XR device, a perceptual quality score for the at least one media stream received from each application of the plurality of applications;
determining, by the XR device, at least one candidate application with different media quality from the plurality of applications based on the perceptual quality score;
determining, by the XR device, a target perceptual quality score for at least one media stream of the at least one candidate application based on the perceptual quality score, capability of the XR device and a plurality of network parameters; and
harmonizing, by the XR device, at least one media parameter of the at least one media stream received from the at least one candidate application based on the target perceptual quality score.

2. The method of claim 1, wherein the at least one media parameter comprises at least one of a bit-rate, a codec, a resolution, a brightness, a frame-complexity, a sample rate, a channel count, a pitch, or a frame-rate.

3. The method of claim 1, wherein the determining, by the XR device, of the target perceptual quality score for the at least one media stream of the at least one candidate application comprises:
determining, by the XR device, a bandwidth ratio based on the plurality of network parameters;
assigning, by the XR device, a weight factor to the at least one candidate application based on the bandwidth ratio; and
determining, by the XR device, the target perceptual quality score for the at least one media stream of the at least one candidate application based on the perceptual quality score, the plurality of network parameters, the assigned weight factor to the at least one candidate application, and the bandwidth ratio.

4. The method of claim 1, wherein the plurality of network parameters comprises at least one of a network bandwidth, network congestion, a network quality of service (QoS) identifier, capability of at least one server from which the at least one media stream is received, or latency requirements.

5. The method of claim 1, wherein the determining, by the XR device, of the perceptual quality score for the at least one media stream received from each application of the plurality of applications comprises:
determining, by the XR device, at least one media parameter of the at least one media stream received from each application of the plurality of applications, and a plurality of XR parameters; and
determining, by the XR device, the perceptual quality score for the at least one media stream received from each application of the plurality of applications based on the at least one media parameter of the at least one media stream received from each application of the plurality of applications and the plurality of XR parameters.

6. The method of claim 5,
wherein the plurality of XR parameters comprises:
a XR rendering space, and
user preferences in the XR rendering space, and
wherein the user preferences in the XR rendering space comprises:
a position of a user in the XR rendering space,
user's observation axis in the position of the user in the XR rendering space,
user's observation range in the position of the user in the XR rendering space, and
user's field of view or focus in the position of the user in the XR rendering space.

7. The method of claim 1, wherein the harmonizing, by the XR device, of the at least one media parameter of the at least one media stream comprises:
determining, by the XR device, whether a capability of the XR device meets a capability threshold, the XR device has service negotiation capability, and the XR device has strict latency requirement; and
performing, by the XR device, one of:
harmonizing, by the XR device, the at least one media parameter of the at least one media stream received from the at least one candidate application using an enhance content harmonizer, when the capability of the XR device meets the capability threshold, the XR device has service negotiation capability, and the latency requirement of the XR device is not strict,
harmonizing, by the XR device, the at least one media parameter of the at least one media stream received from the at least one candidate application using an on-device content harmonizer, when the capability of the XR device meets the capability threshold, the XR device does not has service negotiation capability, and the latency requirement of the XR device is not strict, and
harmonizing, by the XR device, the at least one media parameter of the at least one media stream received from the at least one candidate application using a service level content harmonizer, when the capability of the XR device does not meets the capability threshold, the XR device has service negotiation capability, and the latency requirement of the XR device is strict.

8. The method of claim 7, wherein the harmonizing, by the XR device, of the at least one media parameter of the at least one media stream received from the at least one candidate application using the enhance content harmonizer comprises:
transmitting, by the XR device, a stream renegotiation request to at least one server associated with the at least one candidate application for harmonization of the at least one media stream received from the at least one candidate application, wherein the stream renegotiation request the target perceptual quality score required for the at least one media stream of the at least one candidate application;
receiving, by the XR device, a stream renegotiation response from the at least one server associated with the at least one candidate application accepting the harmonization of the at least one media stream; and
modifying, by the XR device, the at least one media parameter of the at least one media stream received from the at least one candidate application based on the target perceptual quality score when the stream renegotiation response is received from the at least one server, wherein the at least one media parameter of the at least one media stream received from the at least one candidate application is harmonized to change the perceptual quality score of the at least one candidate application to the target perceptual quality score.

9. The method of claim 7, wherein the harmonizing, by the XR device, of the at least one media parameter of the at least one media stream received from the at least one candidate application using the on-device content harmonizer comprises:
modifying, by the XR device, the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score.

10. The method of claim 7, wherein the harmonizing, by the XR device, of the at least one media parameter of the at least one media stream received from the at least one candidate application using the service level content harmonizer comprises:
transmitting, by the XR device, a stream renegotiation request to at least one server associated with the at least one candidate application for harmonization of the at least one media stream, wherein the stream renegotiation request comprises at least one media parameter which needs to be modified for the at least one media stream of the at least one candidate application;
receiving, by the XR device, a stream renegotiation response from the at least one server associated with the at least one candidate application accepting the modification of the at least one media parameter of the at least one media stream of the at least one candidate application;
modifying, by the at least one server, the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score;
sending, by the at least one server, the at least one modified media stream associated with the at least one candidate application to the XR device; and
rendering, by the XR device, the at least one modified media stream associated with the at least one candidate application.

11. An extended reality (XR) device of harmonizing perceptual quality of multiple applications in an XR environment, the XR device comprising:
one or more processors;
a content harmonizer; and
memory storing one or more computer programs including computer-executable instructions that, when executed by the one or more processors, cause the XR device to:
receive at least one media stream received from each application of a plurality of applications available in the XR device,
determine a perceptual quality score for the at least one media stream received from each application of the plurality of applications,
determine at least one candidate application with different media quality from the plurality of applications based on the perceptual quality score,
determine a target perceptual quality score for at least one media stream of the at least one candidate application based on the perceptual quality score, capability of the XR device and a plurality of network parameters, and
harmonize at least one media parameter of the at least one media stream received from the at least one candidate application based on the target perceptual quality score.

12. The XR device of claim 11, wherein the at least one media parameter comprises at least one of a bit-rate, a codec, a resolution, a brightness, a frame-complexity, a sample rate, a channel count, a pitch, or a frame-rate.

13. The XR device of claim 11, wherein, to determine the target perceptual quality score for the at least one media stream of the at least one candidate application, the one or more computer programs further comprise computer-executable instructions that, when executed by the one or more processors, cause the XR device to:
determine a bandwidth ratio based on the plurality of network parameters,
assign a weight factor to the at least one candidate application based on the bandwidth ratio, and
determine the target perceptual quality score for the at least one media stream of the at least one candidate application based on the perceptual quality score, the plurality of network parameters, the assigned weight factor to the at least one candidate application, and the bandwidth ratio.

14. The XR device of claim 11, wherein the plurality of network parameters comprises at least one of a network bandwidth, network congestion, a network quality of service (QoS) identifier, capability of at least one server from which the at least one media stream is received, or latency requirements.

15. The XR device of claim 11, wherein, to determine the perceptual quality score for the at least one media stream received from each application of the plurality of applications, the one or more computer programs further comprise computer-executable instructions that, when executed by the one or more processors, cause the XR device to:
determine at least one media parameter of the at least one media stream received from each application of the plurality of applications, and a plurality of XR parameters, and
determine the perceptual quality score for the at least one media stream received from each application of the plurality of applications based on the at least one media parameter of the at least one media stream received from each application of the plurality of applications and the plurality of XR parameters.

16. The XR device of claim 15,
wherein the plurality of XR parameters comprises:
a XR rendering space, and
user preferences in the XR rendering space, and
wherein the user preferences in the XR rendering space comprises:
a position of a user in the XR rendering space,
user's observation axis in the position of the user in the XR rendering space,
user's observation range in the position of the user in the XR rendering space, and
user's field of view or focus in the position of the user in the XR rendering space.

17. The XR device of claim 11, wherein, to harmonize the at least one media parameter of the at least one media stream received from the at least one candidate application, the one or more computer programs further comprise computer-executable instructions that, when executed by the one or more processors, cause the XR device to:
determine whether a capability of the XR device meets a capability threshold, the XR device has service negotiation capability, and the XR device has latency requirement; and
perform one of:
harmonize the at least one media parameter of the at least one media stream received from the at least one candidate application using an enhance content harmonizer, when the capability of the XR device meets the capability threshold, the XR device has service negotiation capability, and the latency requirement of the XR device is not strict,
harmonize the at least one media parameter of the at least one media stream received from the at least one candidate application using an On-Device content harmonizer, when the capability of the XR device meets the capability threshold, the XR device does not has service negotiation capability, and the latency requirement of the XR device is not strict, and
harmonize the at least one media parameter of the at least one media stream received from the at least one candidate application using a service level content harmonizer, when the capability of the XR device does not meets the capability threshold, the XR device has service negotiation capability, and the latency requirement of the XR device is strict.

18. The XR device of claim 17, wherein, to harmonize the at least one media parameter of the at least one media stream received from the at least one candidate application using the enhance content harmonizer, the one or more computer programs further comprise computer-executable instructions that, when executed by the one or more processors, cause the XR device to:
transmit a stream renegotiation request to at least one server associated with the at least one candidate application for harmonization of the at least one media stream received from the at least one candidate application, wherein the stream renegotiation request the target perceptual quality score required for the at least one media stream of the at least one candidate application,
receive a stream renegotiation response from the at least one server associated with the at least one candidate application accepting the harmonization of the at least one media stream, and
modify the at least one media parameter of the at least one media stream received from the at least one candidate application based on the target perceptual quality score when the stream renegotiation response is received from the at least one server, wherein the at least one media parameter of the at least one media stream received from the at least one candidate application is harmonized to change the perceptual quality score of the at least one candidate application to the target perceptual quality score.

19. The XR device of claim 17, wherein, to harmonize the at least one media parameter of the at least one media stream received from the at least one candidate application using the on-device content harmonizer, the one or more computer programs further comprise computer-executable instructions that, when executed by the one or more processors, cause the XR device to:
modify the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score.

20. The XR device of claim 17, wherein, to harmonize the at least one media parameter of the at least one media stream received from the at least one candidate application using the service level content harmonizer, the one or more computer programs further comprise computer-executable instructions that, when executed by the one or more processors, cause the XR device to:
transmit a stream renegotiation request to at least one server associated with the at least one candidate application for harmonization of the at least one media stream, wherein the stream renegotiation request comprises at least one media parameter which needs to be modified for the at least one media stream of the at least one candidate application,
receive a stream renegotiation response from the at least one server associated with the at least one candidate application accepting the modification of the at least one media stream of the at least one candidate application,
modify the at least one media parameter of the at least one media stream received from the at least one candidate application based on the target perceptual quality score, wherein the at least one media parameter of the at least one media stream received from the at least one candidate application is harmonized to change the perceptual quality score of the at least one candidate application to the target perceptual quality score,
send the at least one modified media stream associated with the at least one candidate application to the XR device,
render the at least one modified media stream associated with the at least one candidate application, and
receive at least one modified media parameter of the at least one media stream associated with the at least one candidate application from the at least one server, wherein the at least one media parameter of the at least one media stream received from the at least one candidate application is modified based on the target perceptual quality score by the at least one servers, wherein the at least one media parameter of the at least one media stream received from the at least one candidate application is harmonized to change the perceptual quality score of the at least one candidate application to the target perceptual quality score.
